(19) United States
(12) Patent Application Publication
(10) Pub. No.: US 2025/0314806 A1
(43) Pub. Date: Oct. 9, 2025

(54) OPTICALLY-ANISOTROPIC LAYER AND MANUFACTURING METHOD OF OPTICALLY-ANISOTROPIC LAYER

(71) Applicant: FUJIFILM Corporation, Tokyo (JP)

(72) Inventors: Keisuke KODAMA, Kanagawa (JP); Keisuke NAKANISHI, Kanagawa (JP); Shunya KATOH, Kanagawa (JP)

(73) Assignee: FUJIFILM Corporation, Tokyo (JP)

(21) Appl. No.: 19/245,472

(22) Filed: Jun. 23, 2025

Related U.S. Application Data
(63) Continuation of application No. PCT/JP2023/043864, filed on Dec. 7, 2023.

(30) Foreign Application Priority Data
Dec. 28, 2022 (JP) 2022-211926

(51) Int. Cl. G02B 1/111

(52) U.S. Cl. CPC G02B 1/111

(57) ABSTRACT

The present invention provides an optically-anisotropic layer having excellent antireflection property, and a manufacturing method of the optically-anisotropic layer. The optically-anisotropic layer of the present invention is an optically-anisotropic layer formed of a composition containing a liquid crystal compound, in which the optically-anisotropic layer has at least one region where a birefringence index Δn continuously changes in a thickness direction and a wavelength dispersion is constant in the thickness direction.

### CROSS-REFERENCE TO RELATED APPLICATIONS

This application is a Continuation of PCT International Application No. PCT/JP2023/043864 filed on Dec. 7, 2023, which claims priority under 35 U.S.C. § 119(a) to Japanese Patent Application No. 2022-211926 filed on Dec. 28, 2022. The above applications are hereby expressly incorporated by reference, in their entirety, into the present application.

### BACKGROUND OF THE INVENTION

### 1. Field of the Invention

The present invention relates to an optically-anisotropic layer and a manufacturing method of an optically-anisotropic layer.

### 2. Description of the Related Art

An optically-anisotropic layer formed of a composition containing a liquid crystal compound is used for various applications such as a diffraction element and a wavelength selective reflection layer. The optically-anisotropic layer is formed by aligning the liquid crystal compound in a predetermined alignment state.

Examples of the optically-anisotropic layer include a λ/2 plate and a λ/4 plate as disclosed in JP2007-188033A.

### SUMMARY OF THE INVENTION

On the other hand, in recent years, it has been required that, in a case where light is incident on the optically-anisotropic layer, reflection on a surface of the optically-anisotropic layer adjacent to air or another member is suppressed as a characteristic required for the optically-anisotropic layer. Hereinafter, the suppression of the reflection on the surface of the optically-anisotropic layer is also referred to as “excellent antireflection property”.

The present inventors have conducted studies on the above-described characteristic of the known optically-anisotropic layer as disclosed in JP2007-188033A, and have found that further improvements are required.

An object of the present invention is to provide an optically-anisotropic layer having excellent antireflection property.

Another object of the present invention is to provide a manufacturing method of the optically-anisotropic layer.

As a result of intensive studies on the problems in the related art, the present inventors have found that the above-described objects can be accomplished by the following configurations.
(1) An optically-anisotropic layer formed of a composition containing a liquid crystal compound,
in which the optically-anisotropic layer has at least one region where a birefringence index Δn continuously changes in a thickness direction and a wavelength dispersion is constant in the thickness direction.
(2) The optically-anisotropic layer according to (1),
in which, in the region, the birefringence index Δn gradually decreases in a direction from one surface of the optically-anisotropic layer toward the other surface of the optically-anisotropic layer.
(3) The optically-anisotropic layer according to (1) or (2),
in which the optically-anisotropic layer has two regions,
one region of the two regions is located on a surface side of any one of the two surfaces of the optically-anisotropic layer,
in the one region, the birefringence index Δn gradually decreases in a direction from a center position of a film thickness of the optically-anisotropic layer toward the one surface,
the other region of the two regions is located on the other surface side of the two surfaces of the optically-anisotropic layer, and
in the other region, the birefringence index Δn gradually decreases in a direction from the center position of the film thickness of the optically-anisotropic layer toward the other surface.
(4) The optically-anisotropic layer according to any one of (1) to (3),
in which a thickness of the region is 0.5 μm or more.
(5) The optically-anisotropic layer according to any one of (1) to (4),
in which, in the region, a ratio of a highest birefringence index Δnₘₐₓ to a lowest birefringence index Δnₘᵢₙ is 2.0 or more.
(6) The optically-anisotropic layer according to any one of (1) to (5),
in which the optically-anisotropic layer is a layer formed by immobilizing the liquid crystal compound which is cholesterically aligned.
(7) The optically-anisotropic layer according to any one of (1) to (6),
in which the liquid crystal compound has a cationically polymerizable group.
(8) The optically-anisotropic layer according to any one of (1) to (7),
in which the composition contains a phenolic compound.
(9) The optically-anisotropic layer according to any one of (1) to (8),
in which the composition contains an ultraviolet absorber.
(10) The optically-anisotropic layer according to any one of (1) to (9),
in which the optically-anisotropic layer has a liquid crystal alignment pattern in which an orientation of an optical axis derived from the liquid crystal compound changes while continuously rotating in at least one in-plane direction.
(11) A manufacturing method of the optically-anisotropic layer according to any one of (1) to (10), the manufacturing method comprising:
a step 1 of forming a coating film using a composition which contains a liquid crystal compound having a polymerizable group, and aligning the liquid crystal compound in the formed coating film;
a step 2 of polymerizing the liquid crystal compound such that a region where a polymerization rate of the liquid crystal compound continuously changes is formed in a thickness direction of the coating film; and
a step 3 of subjecting the coating film obtained in the step 2 to a heating treatment to form a region where a birefringence index Δn continuously changes in the thickness direction and a wavelength dispersion is constant.

According to the present invention, it is possible to provide an optically-anisotropic layer having excellent antireflection property.

According to the present invention, it is possible to provide a manufacturing method of the optically-anisotropic layer.

### BRIEF DESCRIPTION OF THE DRAWINGS

FIG. 1 is a cross-sectional view showing an example of an optically-anisotropic layer according to the embodiment of the present invention.

FIG. 2 is an enlarged cross-sectional view of a part of the optically-anisotropic layer for describing a region where a birefringence index Δn continuously changes in a thickness direction and a wavelength dispersion is constant in the thickness direction.

FIG. 3 is a cross-sectional view showing another example of the optically-anisotropic layer according to the embodiment of the present invention.

FIG. 4 is a cross-sectional view showing another example of the optically-anisotropic layer according to the embodiment of the present invention.

FIG. 5 is a plan view of the optically-anisotropic layer shown in FIG. 4.

FIG. 6 is a plan view showing another example of the optically-anisotropic layer according to the embodiment of the present invention.

FIG. 7 is a view showing a procedure for manufacturing the optically-anisotropic layer according to the embodiment of the present invention.

FIG. 8 is a view conceptually showing an example of an exposure device for producing a photo-alignment film.

FIG. 9 is a diagram showing an example of a birefringence index distribution in the thickness direction in a case where the wavelength dispersion of the optically-anisotropic layer is constant in the thickness direction.

FIG. 10 is a view showing an example of a birefringence index distribution in the thickness direction in a case where the wavelength dispersion of the optically-anisotropic layer is not constant in the thickness direction.

### DESCRIPTION OF THE PREFERRED EMBODIMENTS

Hereinafter, the present invention will be described in detail.

Although configuration requirements to be described below are described based on representative embodiments of the present invention, the present invention is not limited to the embodiments.

In the present specification, numerical ranges represented by “to” include numerical values before and after “to” as lower limit values and upper limit values.

In the present specification, for each component, one kind of substance corresponding to each component may be used alone, or two or more kinds thereof may be used in combination. Here, in a case where two or more kinds of substances are used in combination for each component, the content of the component indicates the total content of the substances used in combination, unless otherwise specified.

In the present specification, “(meth)acrylate” is used to mean “either or both of acrylate and methacrylate”.

In the present specification, the solid content means components forming the optically-anisotropic layer, and does not include a solvent. The component forming the optically-anisotropic layer may be a component in which a chemical structure changes by a reaction (polymerization) in a case of forming the optically-anisotropic layer. In addition, even in a case where the component is liquid, the component is included in the solid content as long as the component forms the optically-anisotropic layer.

A bonding direction of divalent groups cited in the present specification is not limited unless otherwise specified. For example, in a case where Y in a compound represented by Formula “X—Y—Z” is —COO—, Y may be —CO—O— or —O—CO—. In addition, the above-described compound may be “X—CO—O—Z” or “X—O—CO—Z”.

In the present specification, a birefringence index is obtained by measuring Re(λ) and dividing the Re(λ) by a thickness.

In the present specification, Re(λ) and Rth(λ) represent an in-plane retardation and a thickness-direction retardation at a wavelength λ, respectively. Unless otherwise specified, the wavelength λ is 550 nm.

In the present specification, Re(λ) and Rth(λ) are values measured at the wavelength λ using AxoScan (manufactured by Axometrics, Inc.). By inputting an average refractive index ((nx+ny+nz)/3) and a film thickness (d (μm)) in AxoScan, an in-plane slow axis direction) (°), Re(λ)=R0(λ), and Rth(λ)=((nx+ny)/2−nz)×d are calculated.

Although R0(λ) is described as a numerical value calculated by AxoScan, it means Re(λ).

In the present specification, the refractive indices nx, ny, and nz are measured using an Abbe refractometer (NAR-4T, manufactured by Atago Co., Ltd.) and using a sodium lamp (λ=589 nm) as a light source. In addition, in a case of measuring the wavelength dependence, it can be measured with a multi-wavelength Abbe refractometer DR-M2 (manufactured by Atago Co., Ltd.) in combination with a dichroic filter.

In addition, values in Polymer Handbook (John Wiley & Sons, Inc.) and catalogs of various optical films can be used. Values of the average refractive index of main optical films are exemplified as follows: cellulose acylate (1.48), cycloolefin polymer (1.52), polycarbonate (1.59), polymethylmethacrylate (1.49), and polystyrene (1.59).

A feature point of the optically-anisotropic layer according to the embodiment of the present invention is that the optically-anisotropic layer has a region (hereinafter, also simply referred to as “specific region”) where a birefringence index Δn continuously changes in a thickness direction and a wavelength dispersion is constant in the thickness direction.

In a case of the optically-anisotropic layer in the related art, as light is incident into the optically-anisotropic layer, reflection is likely to occur on a surface of the optically-anisotropic layer. Regarding the reason why such a problem occurs, in a case where an optically-anisotropic layer containing a liquid crystal compound which is homogeneously aligned is taken as an example, the liquid crystal compound is homogeneously aligned on the surface of the optically-anisotropic layer, and thus, there are a direction in which a refractive index in a slow axis direction is high and a direction in which a refractive index in a fast axis direction is low. In a case where the surface of the optically-anisotropic layer is adjacent to air, a difference between the refractive index of the optically-anisotropic layer in the slow axis direction and the refractive index of air are larger than a difference between the refractive index of the optically-anisotropic layer in the fast axis direction and the refractive index of air, and thus reflection of polarized light in the slow axis direction is more likely to occur. That is, in a case where the birefringence index Δn of the surface of the optically-anisotropic layer is large, reflection in any direction is likely to occur.

On the other hand, in the optically-anisotropic layer according to the embodiment of the present invention the above-described problem is solved by having the above-described specific region. For example, in a case where the optically-anisotropic layer according to the embodiment of the present invention has the specific region where the birefringence index Δn gradually decreases toward the air side, the refractive index of the optically-anisotropic layer gradually decreases in a specific direction in which the difference in refractive index with air is large toward the air side, and as a result, the occurrence of reflection at the interface between the air and the optically-anisotropic layer is suppressed. As described above, in the present invention, by providing the specific region, rapid occurrence of the difference in refractive index can be suppressed, and as a result, antireflection property is improved.

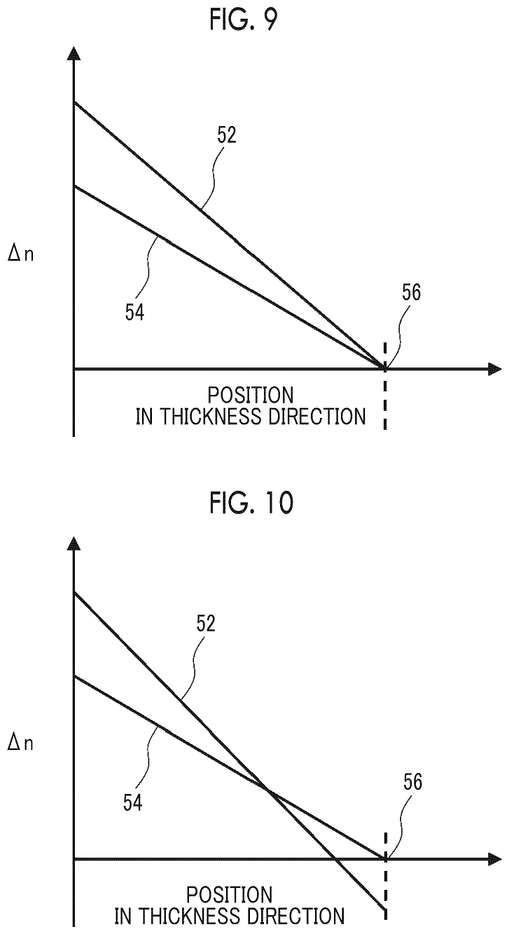

In addition, in the optically-anisotropic layer according to the embodiment of the present invention, the specific region has a constant wavelength dispersion in the thickness direction. In a case where the wavelength dispersion is constant, for example, the birefringence index of the interface can be close to zero in all wavelength ranges, and in such a case, excellent antireflection ability can be obtained in a case of being in contact with an isotropic medium. The reason will be described with reference to FIGS. 9 and 10.

FIG. 9 shows an example of a birefringence index distribution in the thickness direction in a case where the wavelength dispersion of the optically-anisotropic layer is constant in the thickness direction. FIG. 10 shows an example of a birefringence index distribution in the thickness direction in a case where the wavelength dispersion of the optically-anisotropic layer is not constant in the thickness direction.

In FIGS. 9 and 10, a straight line 52 represents a birefringence index at a short wavelength (for example, 450 nm), a straight line 54 represents a birefringence index at a long wavelength (for example, 550 nm), and a point 56 represents a position of an interface on a side where the birefringence index is small.

As can be seen from the comparison between FIGS. 9 and 10, in a case where the wavelength dispersion is constant, the birefringence index of the layer interface can be set to zero in all wavelength ranges. Therefore, for example, in a case where the optically-anisotropic layer is in contact with an isotropic medium, since there is no difference in birefringence index at the interface, excellent antireflection ability can be obtained. Furthermore, in a case where the optically-anisotropic layer consists of a liquid crystal which is cholesterically aligned, it is considered that a side lobe of the cholesteric liquid crystal can be reduced in all wavelength ranges, and thus excellent antireflection ability can be obtained.

In addition, in a case where the wavelength dispersion is constant, a slope of the straight line 52 representing the birefringence index at a short wavelength is small as compared with a case where the wavelength dispersion is not constant, that is, the change in birefringence index inside the optically-anisotropic layer is gentle. As a result of the examination, in order to exhibit the antireflection ability, it is desirable that the change in birefringence index inside the optically-anisotropic layer is gentle, and particularly, in a case where the optically-anisotropic layer consists of a liquid crystal which is cholesterically aligned, the effect of reducing the side lobe is remarkable in a case where the change in birefringence index is gentle. Therefore, it is considered that excellent antireflection ability can be obtained in a case where the wavelength dispersion is constant.

As will be described later, the above-described wavelength dispersion characteristic can also be achieved by forming the specific region using one type of liquid crystal compound.

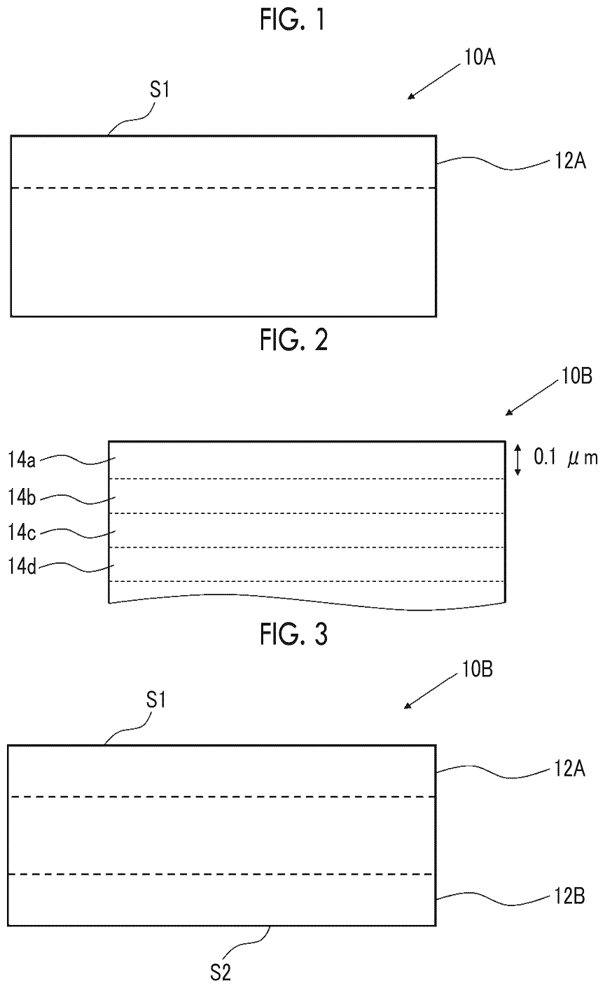

In addition, in a case where the optically-anisotropic layer is an optically-anisotropic layer having reflection characteristics of a cholesteric liquid crystal layer (a layer containing a liquid crystal compound which is cholesterically aligned), the occurrence of side lobe is suppressed by having the specific region. The side lobe means a portion where reflectivity is relatively large at a wavelength in the vicinity of the outside of the reflection wavelength range, as shown in FIG. 1 of WO2022/239835A. When the side lobe occurs, light having a wavelength which should not be reflected originally is reflected, which is not preferable.

### Optically-Anisotropic Layer

FIG. 1 shown a cross-sectional view showing an example of the optically-anisotropic layer according to the embodiment of the present invention.

As shown in FIG. 1, an optically-anisotropic layer 10A has a specific region 12A on one surface S1 side. In the specific region 12A, the birefringence index Δn gradually decreases toward the surface S1 side, and the wavelength dispersion is constant in the thickness direction.

The specific region 12A is disposed on the other surface S1 side with respect to a center position of a film thickness of the optically-anisotropic layer, and in the specific region 12A, the birefringence index Δn gradually decreases in a direction from the center position of the film thickness of the optically-anisotropic layer toward the one surface S1.

Hereinafter, first, the specific region 12A will be described in detail.

The optically-anisotropic layer according to the embodiment of the present invention has a region in which the birefringence index Δn continuously changes in the thickness direction and the wavelength dispersion is constant in the thickness direction, and the above-described specific region 12A corresponds to one aspect of the region.

In the optically-anisotropic layer according to the embodiment of the present invention, the fact that the birefringence index Δn continuously changes in the thickness direction means that the birefringence index Δn in a region having a thickness of 0.1 μm continuously changes in the thickness direction. That is, in a case where the optically-anisotropic layer is divided into regions for each thickness of 0.1 μm, the birefringence index Δn of each region is calculated; and in a case where the birefringence index Δn continuously changes in the thickness direction, one requirement of the specific region is satisfied.

More specifically, first, an optically-anisotropic layer 10B is divided into regions for each thickness of 0.1 μm, as in the optically-anisotropic layer 10B shown in FIG. 2. In FIG. 2, divided regions 14a to 14d are shown as a part of the divided regions (divided region). Next, the birefringence index Δn of the divided region including each of the divided regions 14a to 14d is calculated.

A method of calculating the birefringence index Δn of each divided region is not particularly limited, and as an example, there is a method of etching a part of the optically-anisotropic layer and calculating the birefringence index Δn from a difference in phase difference (Re) before and after the etching. For example, a sample 1 in which the divided region 14a is removed and a sample 2 in which the divided regions 14a and 14b are removed are prepared by performing etching from the surface of the optically-anisotropic layer 10B. Next, phase differences of the samples 1 and 2 are calculated using Axoscan (manufactured by Axometrics, Inc.). Next, the phase difference of the divided region 14b is calculated from the difference in phase difference between the samples 1 and 2. Since the phase difference corresponds to the product of the birefringence index Δn and the thickness, the birefringence index Δn of the divided region 14b can be calculated based on the calculated phase difference of the divided region 14b.

In addition, in a case where the liquid crystal compound is cholesterically aligned in the optically-anisotropic layer or the optically-anisotropic layer has a liquid crystal alignment pattern described later, whether the birefringence index Δn continuously changes is measured by the following method.

First, with the samples 1 and 2 produced by the above-described procedure, the phase difference measurement with respect to incidence ray from a normal direction is performed using Axoscan; and with respect to the detected slow axis and fast axis, the phase difference measurement is further performed in a slow axis direction and a polar angle direction of −40° or 40°, and the phase difference measurement is further performed in a fast axis direction and a polar angle direction of −40° or 40°. That is, the phase difference measurement is performed in the above-described four directions, and an average value of the obtained measured values is calculated as the oblique-direction phase difference Re(40). Next, a difference between the oblique-direction phase difference Re(40) of the sample 1 and the oblique-direction phase difference Re(40) of the sample 2 is calculated to obtain an oblique-direction phase difference Re(40) of the divided region 14b. Such an operation is performed on each divided region to obtain an oblique-direction phase difference Re(40) of each divided region. In general, since the phase difference is in a proportional relationship with the birefringence index Δn, in a case where the oblique-direction phase difference Re(40) of each divided region continuously changes, it can be defined that the birefringence index Δn of each divided region continuously changes.

In the present invention, the birefringence index Δn means a birefringence index Δn at a wavelength of 550 nm.

In addition, the birefringence index Δn means a difference between a refractive index in a direction in which the refractive index is maximum and a refractive index in a direction orthogonal to the direction in which the refractive index is maximum.

In addition, in the optically-anisotropic layer according to the embodiment of the present invention, the fact that the wavelength dispersion in the specific region is constant in the thickness direction means that the wavelength dispersion in a region (region L) having a birefringence index equal to more than an average birefringence index in a Δn-changing region, which is included in the specific region where the birefringence index Δn continuously changes in the thickness direction, specified by the above-described method (hereinafter, also referred to as a Δn-changing region), coincides with the wavelength dispersion in a region (region S) having a birefringence index less than the average birefringence index in the Δn changing region, which is included in the Δn-changing region.

The wavelength dispersion in the region (region L) having a birefringence index equal to more than the average birefringence index in the Δn-changing region and the wavelength dispersion in the region (region S) having a birefringence index less than the average birefringence index in the Δn-changing region can be calculated by the following procedures a) to c).
a) With reference to a method of dividing the Δn-changing region into regions for each thickness of 0.1 μm and calculating the birefringence index Δn of the divided region, a birefringence index Δn450 at a wavelength of 450 nm and a birefringence index Δn550 at a wavelength of 550 nm in each divided region are calculated.
b) An average value Δn550ave of the birefringence indices Δn550 at the wavelength of 550 nm in each of the divided regions is calculated, and the divided region (region L) where the birefringence index Δn550 is equal to or more than the average value Δn550ave and the divided region (region S) where the birefringence index Δn550 is less than the average value Δn550ave are specified.
c) An average value Δn450L of the birefringence indices Δn450 in the region L and an average value Δn550L of the birefringence indices Δn550 in the region L are calculated, and a ratio of both (average value Δn450L/average value Δn550L) is calculated as a wavelength dispersion Δn450 L/Δn550L in the region L; similarly, an average value Δn450S of the birefringence indices Δn450 in the region S and an average value Δn550S of the birefringence indices Δn550 in the region S are calculated, and a ratio of both (average value Δn450S/average value Δn550S) is calculated as a wavelength dispersion Δn450S/Δn550S in the region S.

In the present invention, the fact that the wavelength dispersion is constant in the thickness direction means that the wavelength dispersion Δn450S/Δn550S in the region S is within a range of ±20% with respect to the wavelength dispersion Δn450L/Δn550L in the region L, and the wavelength dispersion Δn450S/Δn550S is preferably within ±10% and more preferably within ±5%. That is, the fact that the wavelength dispersion is constant in the thickness direction means that an A value calculated by the following expression is in a range of −20% to 20%; and in a case where the A value is in this numerical range, the wavelength dispersion in the region (region L) having a birefringence index of equal to or more than the average birefringence index in the Δn-changing region and the wavelength dispersion in the region (region S) having a birefringence index of less than the average birefringence index in the Δn-changing region, which are included in the Δn-changing region, are considered to coincide with each other.

$$A value = \{ ( Wavelength dispersion Δ n 450 S / Δ n 550 S - Wavelength dispersion Δ n 450 L / Δ n 550 L ) / Wavelength dispersion Δ n 450 L / Δ n 550 L \} \times 100$$

In a case where the liquid crystal compound is cholesterically aligned in the optically-anisotropic layer or the optically-anisotropic layer has a liquid crystal alignment pattern described later, the oblique-direction phase difference Re(40, 450) at a polar angle of 40° and at a wavelength of 450 nm and the oblique-direction phase difference Re(40, 550) at a polar angle of 40° and at a wavelength of 550 nm in each divided region are calculated, the oblique-direction phase difference is used instead of the birefringence index using the same method as that of b) and c) described above, and it can be confirmed that the wavelength dispersion is constant.

The oblique-direction phase difference Re(40, 450) at a polar angle of 40° and at a wavelength of 450 nm is calculated by the following method. First, with respect to a slow axis and a fast axis in the divided region detected by Axoscan, the phase difference measurement at a wavelength of 450 nm is performed in a slow axis direction and a polar angle direction of −40° or 40°, and then a phase difference measurement at a wavelength of 450 nm is further performed in a fast axis direction and a polar angle direction of −40° or 40°, and an average value of the obtained measured values is calculated as the above-described oblique-direction phase difference Re(40, 450).

In addition, the oblique-direction phase difference Re(40, 550) at a polar angle of 40° and at a wavelength of 550 nm is calculated by the following method. First, with respect to a slow axis and a fast axis in the divided region detected by Axoscan, the phase difference measurement at a wavelength of 550 nm is performed in a slow axis direction and a polar angle direction of −40° or 40°, and then a phase difference measurement at a wavelength of 550 nm is further performed in a fast axis direction and a polar angle direction of −40° or 40°, and an average value of the obtained measured values is calculated as the above-described oblique-direction phase difference Re(40, 550).

In a case where there is a region where the birefringence index Δn of the divided region of the optically-anisotropic layer 10B, calculated by the above-described procedure, continuously changes and the wavelength dispersion is constant, the region is defined as the specific region. For example, in a case where the birefringence index Δn continuously changes in the divided regions 14a to 14d and the wavelength dispersion is constant, the region consisting of the divided regions 14a to 14d corresponds to the specific region.

In the specific region 12A shown in FIG. 1, the birefringence index Δn gradually decreases toward the surface S1 side, and the wavelength dispersion is constant in the thickness direction. That is, in the specific region 12A, in a case where the specific region 12A is divided into regions for each thickness of 0.1 μm and the birefringence index Δn of each divided region is calculated, the birefringence index Δn of the divided region gradually decreases toward the surface S1 side. In addition, in the specific region 12A, the wavelength dispersion is constant in a case where the wavelength dispersion of each divided region is calculated.

In FIG. 1, the aspect of the optically-anisotropic layer 10A having the specific region 12A where birefringence index Δn gradually decreases toward the surface S1 side and the wavelength dispersion is constant in the thickness direction has been described, but the present invention is not limited to this aspect.

For example, the optically-anisotropic layer according to the embodiment of the present invention may have a specific region where the birefringence index Δn gradually increases toward any one of two main surfaces of the optically-anisotropic layer and the wavelength dispersion is constant in the thickness direction.

That is, in the specific region of the optically-anisotropic layer according to the embodiment of the present invention, the birefringence index Δn may gradually decrease or may gradually increase. In addition, the direction of the gradual increase or the gradual decrease is not particularly limited.

In addition, in FIG. 1, the specific region 12A is disposed from the surface S1 along the thickness direction, but the position of the specific region in the optically-anisotropic layer is not particularly limited. For example, the specific region may be formed in the entire film thickness of the optically-anisotropic layer.

In addition, in FIG. 1, the optically-anisotropic layer 10A has one specific region 12A, but the optically-anisotropic layer may have two specific regions.

For example, an optically-anisotropic layer 10B shown in FIG. 3 has a specific region 12A and a specific region 12B. As described above, the specific region 12A is a region disposed on the surface S1 side, where the birefringence index Δn gradually decreases toward the surface S1 side and the wavelength dispersion is constant in the thickness direction.

The specific region 12B is a region disposed on a surface S2 side, where the birefringence index Δn gradually decreases toward the surface S2 side and the wavelength dispersion is constant in the thickness direction. That is, the specific region 12B is disposed on the other surface S2 side with respect to a center position of a film thickness of the optically-anisotropic layer, and in the specific region 12B, the birefringence index Δn gradually decreases in a direction from the center position of the film thickness of the optically-anisotropic layer toward the one surface S2.

In a case where the optically-anisotropic layer is a cholesteric liquid crystal layer, the occurrence of side lobe is suppressed as described above as the optically-anisotropic layer has the two specific regions shown in FIG. 3.

In addition, in the specific region of the optically-anisotropic layer according to the embodiment of the present invention, a ratio of the maximum birefringence index Δnₘₐₓ to the minimum birefringence index Δnₘᵢₙ is not particularly limited, and is often 1.2 or more, preferably 2.0 or more from the viewpoint that the antireflection property of the optically-anisotropic layer is more excellent (hereinafter, also simply referred to as “viewpoint that the effect of the present invention is more excellent”). The upper limit thereof is not particularly limited, and may be infinity (that is, Δnₘᵢₙ is 0), often 100 or less and more often 20 or less.

As a method of calculating the birefringence index Δnₘᵢₙ and the birefringence index Δnₘₐₓ in the specific region, the birefringence index Δn of each divided region is calculated as described above; and the largest value of the birefringence index Δn of the divided regions is defined as the birefringence index Δnₘₐₓ, and the smallest value of the birefringence index Δn of the divided regions is defined as the birefringence index Δnₘᵢₙ.

A magnitude of the above-described birefringence index Δnₘᵢₙ is not particularly limited, but is preferably 0.00 to 0.20, more preferably 0.00 to 0.10, and still more preferably 0.00 to 0.05 from the viewpoint that the effect of the present invention is more excellent.

A magnitude of the birefringence index Δnₘₐₓ is not particularly limited, but is preferably 0.005 to 0.50, more preferably 0.01 to 0.45, and still more preferably 0.03 to 0.40 from the viewpoint that the effect of the present invention is more excellent.

A thickness of the specific region in the optically-anisotropic layer is not particularly limited, but is preferably 0.3 μm or more and more preferably 0.5 μm or more from the viewpoint that the antireflection property of the optically-anisotropic layer is more excellent (hereinafter, also simply referred to as “viewpoint that the effect of the present invention is more excellent”). The upper limit thereof is not particularly limited, and examples thereof include the total film thickness of the optically-anisotropic layer.

A proportion of the thickness of the specific region to the total film thickness of the optically-anisotropic layer is not particularly limited, but from the viewpoint that the effect of the present invention is more excellent, it is preferably 20% to 100% and more preferably 60% to 100%, and it is still more preferable that the entire layer is the specific region.

A thickness of the optically-anisotropic layer is not particularly limited, but is more preferably 0.5 μm or more and still more preferably 1.5 μm or more. The upper limit thereof is not particularly limited, and is preferably 20 μm or less and more preferably 15 or μm or less.

An alignment state of the liquid crystal compound in the optically-anisotropic layer is not particularly limited, and examples thereof include known alignment states. Examples of the alignment state include a homogeneous alignment, a homeotropic alignment, a hybrid alignment, a cholesteric alignment, a twisted alignment, and a tilt alignment. The above-described twisted alignment refers to an alignment state in which the liquid crystal compound is twisted from one main surface to another main surface of the optically-anisotropic layer with the thickness direction of the optically-anisotropic layer as a rotation axis. In the twisted alignment, a twisted angle of the liquid crystal compound (twisted angle of the liquid crystal compound in an alignment direction) is typically more than 0° and 360° or less in many cases.

The optically-anisotropic layer is preferably a layer on which an aligned liquid crystal compound is immobilized. In a case where the liquid crystal compound has a polymerizable group, the alignment state of the liquid crystal compound can be easily immobilized by a curing treatment described later.

The “immobilized” state is a state in which the alignment of a liquid crystal compound is maintained. Specifically, the “immobilized” state is preferably a state in which, in a temperature range of usually 0° C. to 50° C. or in a temperature range of −30° C. to 70° C. under more severe conditions, the layer has no fluidity and a fixed alignment morphology can be stably maintained without causing a change in the alignment morphology due to an external field or an external force.

The optically-anisotropic layer may have a liquid crystal alignment pattern in which an orientation of an optical axis derived from the liquid crystal compound changes while continuously rotating in at least one in-plane direction.

Hereinafter, the liquid crystal alignment pattern will be described in detail.

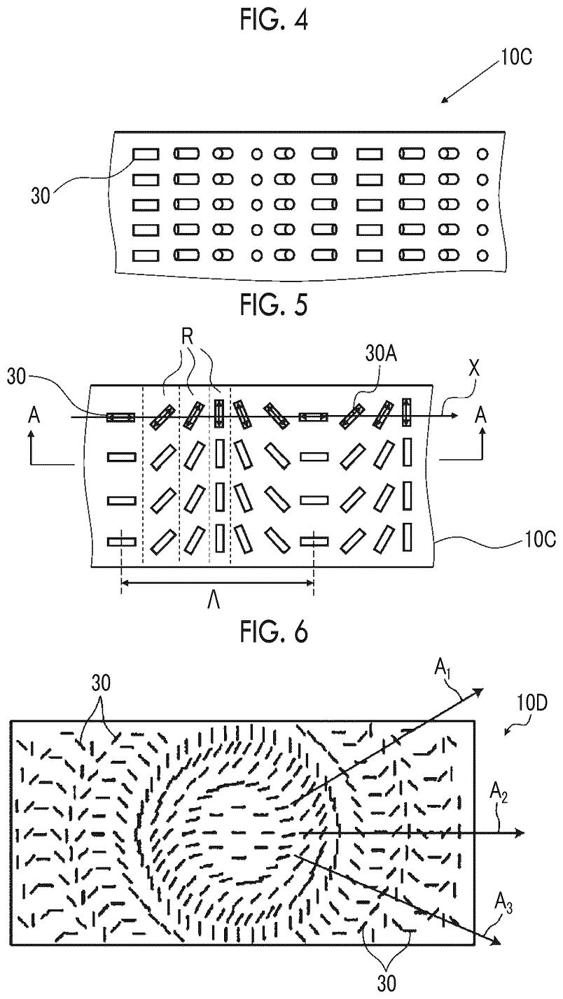

FIG. 5 is a plan view of the optically-anisotropic layer shown in FIG. 4. FIG. 4 is a cross-sectional view taken along line A-A in FIG. 5.

The plan view is a view in a case where an optically-anisotropic layer 10C is seen from above in FIG. 4, that is, FIG. 5 is a view in a case where the optically-anisotropic layer 10C is seen from the thickness direction.

In FIG. 5, in order to clarify the configuration of the optically-anisotropic layer 10C, only the liquid crystal compound 30 on the surface side of the optically-anisotropic layer 10C is shown. However, as shown in FIG. 4, the optically-anisotropic layer 10C has a structure in which the liquid crystal compounds 30 are stacked in the thickness direction.

The optically-anisotropic layer 10C shown in FIG. 4 has a predetermined liquid crystal alignment pattern in which the orientation of the optical axis derived from the liquid crystal compound 30 rotates in one in-plane direction.

The optically-anisotropic layer 10C is formed of a composition containing a liquid crystal compound described later.

As shown in FIG. 5, the optically-anisotropic layer 10C has a liquid crystal alignment pattern in which an orientation of an optical axis 30A derived from the liquid crystal compound 30 changes while continuously rotating counterclockwise in the one direction indicated by an arrow X in a plane of the optically-anisotropic layer 10C. In FIG. 5, the orientation of the optical axis 30A derived from the liquid crystal compound 30 rotates counterclockwise. However, the present invention is not limited to this aspect, and the orientation of the optical axis 30A may rotate clockwise.

The optical axis 30A derived from the liquid crystal compound 30 is an axis having the highest refractive index in the liquid crystal compound 30. For example, in a case where the liquid crystal compound 30 is a rod-like liquid crystal compound, the optical axis 30A is along a major axis direction of the rod shape.

In the following description, the “one direction indicated by an arrow X” will also be simply referred to as “arrow X direction”. In addition, in the following description, the optical axis 30A derived from the liquid crystal compound 30 will also be referred to as “optical axis 30A of the liquid crystal compound 30” or “optical axis 30A”.

In the optically-anisotropic layer 10C, the liquid crystal compound 30 is two-dimensionally aligned in a plane parallel to the arrow X direction and a Y direction orthogonal to the arrow X direction. In FIG. 4, the Y direction is a direction perpendicular to the paper plane.

As described above, the optically-anisotropic layer 10C has the liquid crystal alignment pattern in which the orientation of the optical axis 30A derived from the liquid crystal compound 30 changes while continuously rotating in the arrow X direction in the plane of the optically-anisotropic layer 10C.

Specifically, the “orientation of the optical axis 30A of the liquid crystal compound 30 changes while continuously rotating in the arrow X direction (predetermined one direction)” means that an angle between the optical axis 30A of the liquid crystal compound 30, which is arranged in the arrow X direction, and the arrow X direction varies depending on positions in the arrow X direction, and the angle between the optical axis 30A and the arrow X direction sequentially changes from θ to θ+180° or to θ−180° in the arrow X direction.

The difference between the angles of the optical axes 30A of the liquid crystal compounds 30 adjacent to each other in the arrow X direction is preferably 45° or less, and more preferably 15° or less.

Meanwhile, regarding the liquid crystal compound 30 forming the optically-anisotropic layer 10C, the liquid crystal compounds 30 in which the orientations of the optical axes 30A are the same as one another are arranged at equal intervals in the Y direction orthogonal to the arrow X direction, that is, the Y direction orthogonal to one direction in which the optical axes 30A continuously rotate.

In other words, regarding the liquid crystal compound 30 forming the optically-anisotropic layer 10C, in the liquid crystal compounds 30 arranged in the Y direction, angles between the orientations of the optical axes 30A and the arrow X direction are the same.

In such a liquid crystal alignment pattern of the liquid crystal compound 30, the length (distance) over which the optical axis 30A of the liquid crystal compound 30 rotates by 180° in the arrow X direction that the orientation of the optical axis 30A continuously change while continuously rotating in a plane is defined by a length Λ of a single period in the liquid crystal alignment pattern. In other words, the length of the single period in the liquid crystal alignment pattern is defined as the distance between θ and θ+180° that is a range of the angle between the optical axis 30A of the liquid crystal compound 30 and the arrow X direction.

That is, in the arrow X direction, a distance between centers of two liquid crystal compounds 30 having the same angle with respect to the arrow X direction is set as the length Λ of the single period. Specifically, as shown in FIG. 5, the distance between the centers of two liquid crystal compounds 30 in which the arrow X direction and the direction of the optical axis 30A coincide with each other in the arrow X direction is set as the length Λ of the single period. In the description below, the length Λ of the single period is also referred to as “single period Λ”.

With regard to the optically-anisotropic layer 10C, in the liquid crystal alignment pattern of the optically-anisotropic layer 10C, the single period Λ is repeated in the arrow X direction, that is, in the one direction in which the orientation of the optical axis 30A changes while continuously rotating.

As described above, in the optically-anisotropic layer 10C, the liquid crystal compounds 30 arranged in the Y direction have the same angle between the optical axis 30A and the arrow X direction (one direction in which the orientation of the optical axis of the liquid crystal compound 30 rotates). A region where the liquid crystal compounds 30 in which the angles between the optical axes 30A and the arrow X direction are the same are arranged in the Y direction will be referred to as a region R.

In this case, it is preferable that an in-plane retardation (Re) value of each of the regions R is a half wavelength, that is, λ/2. The in-plane retardation is calculated by the product of the birefringence index Δn of the region R and the thickness of the optically-anisotropic layer. Here, the refractive index anisotropy of the regions R in the optically-anisotropic layer is defined by a difference between a refractive index of a direction of an in-plane slow axis of the region R and a refractive index of a direction orthogonal to the direction of the slow axis. That is, the birefringence index Δn of the region R is the same as a difference between a refractive index of the liquid crystal compound 30 in the direction of the optical axis 30A and a refractive index of the liquid crystal compound 30 in a direction perpendicular to the optical axis 30A in a plane of the region R.

It is not necessary that the above-described 180° rotation period in the optically-anisotropic layer 10C is uniform over the entire surface. That is, the optically-anisotropic layer 10C may have regions having different lengths of the 180° rotation periods (lengths Λ of the single periods) in a plane.

The minimum value of the length of the single period over which the orientation of the optical axis derived from the liquid crystal compound rotates by 180° in a plane is preferably 20 μm or less, more preferably 5 μm or less, and still more preferably 2 μm or less. The lower limit thereof is not particularly limited, but is 0.5 μm or more in many cases.

In addition, the optically-anisotropic layer 10C may have a portion where the orientation of the optical axis is constant as long as a part thereof has the liquid crystal alignment pattern in which the orientation of the optical axis rotates in at least one in-plane direction.

In the liquid crystal alignment pattern of the optically-anisotropic layer 10C shown in FIGS. 4 and 5, the orientation of the optical axis 30A of the liquid crystal compound 30 continuously rotates only in the arrow X direction.

However, the present invention is not limited thereto, and various configurations can be used as long as the orientation of the optical axis 30A of the liquid crystal compound 30 in the optically-anisotropic layer continuously rotates in one in-plane direction.

Examples thereof include an optically-anisotropic layer 10D conceptually shown in a plan view of FIG. 6, in which a liquid crystal alignment pattern is a concentric circular pattern having a concentric circular shape where one in-plane direction in which the orientation of the optical axis of the liquid crystal compound 30 changes while continuously rotating moves from an inner side toward an outer side. In other words, the liquid crystal alignment pattern of the optically-anisotropic layer 10D shown in FIG. 6 is a liquid crystal alignment pattern which has the one direction in which the orientation of the optical axis of the liquid crystal compound 30 changes while continuously rotating, in a radial shape from the center of the optically-anisotropic layer 10D. Specifically, in the optically-anisotropic layer 10D, the orientation of the optical axis 30A changes while continuously rotating in a direction in which a large number of optical axes move to the outer side from the center of the optically-anisotropic layer 10D, such as the direction indicated by the arrow A₁, the direction indicated by the arrow A₂, and the direction indicated by the arrow A₃.

### Composition

### Liquid Crystal Compound

The optically-anisotropic layer is formed of a composition containing a liquid crystal compound.

In general, the liquid crystal compound can be classified into a rod-like type and a disk-like type according to the shape thereof. Furthermore, there are a low-molecular-weight type and a high-molecular-weight type for each of the rod-like type liquid crystal compound and the disk-like type liquid crystal compound. The term “high-molecular-weight” generally refers to a compound having a degree of polymerization of 100 or more (Polymer Physics-Phase Transition Dynamics, written by Masao Doi, p. 2, published by Iwanami Shoten, 1992). In the present invention, any liquid crystal compound can be used, but a rod-like liquid crystal compound or a disk-like liquid crystal compound is preferable. In addition, a liquid crystal compound which is a monomer or has a relatively low molecular weight with a degree of polymerization of less than 100 is preferable.

As the rod-like liquid crystal compound, for example, those described in claim 1 of JP1999-513019A (JP-H11-513019A) or paragraphs to of JP2005-289980A are preferable; and as the disk-like liquid crystal compound, those described in paragraphs [0020] to [0067] of JP2007-108732A or paragraphs [0013] to [0108] of JP2010-244038A are preferable.

A liquid crystal compound having reverse wavelength dispersibility can be used as the above-described liquid crystal compound.

Here, in the present specification, the liquid crystal compound having “reverse wavelength dispersibility” refers to the fact that, in the measurement of an in-plane retardation (Re) value at a specific wavelength (visible light range) of a retardation film produced using the liquid crystal compound, as the measurement wavelength increases, the Re value is the same or increased.

The liquid crystal compound preferably has a polymerizable group. That is, the liquid crystal compound is preferably a polymerizable liquid crystal compound. Examples of the polymerizable group included in the liquid crystal compound include a radically polymerizable group such as an acryloyl group, a methacryloyl group, and a vinyl group, and a cationically polymerizable group such as an epoxy group.

By polymerizing such a polymerizable liquid crystal compound, the alignment of the liquid crystal compound can be fixed. After immobilizing the liquid crystal compound by polymerization, it is no longer necessary to exhibit liquid crystallinity.

As the liquid crystal compound, a liquid crystal compound having both the cationically polymerizable group and the radically polymerizable group is preferable. With such a liquid crystal compound, the optically-anisotropic layer can be efficiently manufactured as described later.

As the liquid crystal compound, a liquid crystal compound represented by Formula (I) (hereinafter, also referred to as “specific liquid crystal compound”) is preferable.

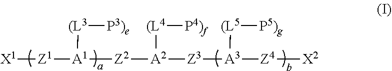

In Formula (I),
X¹ represents a hydrogen atom or a group represented by *-L¹-P¹,
where * represents a bonding position,
X² represents a hydrogen atom or a group represented by *-L²-P², where * represents a bonding position,
P¹ to P⁵ each independently represent a polymerizable group represented by any one of Formulae (Ia) to (Ij) described later; among the groups included in the liquid crystal compound represented by Formula (I) as any of P¹ to P⁵, at least one represents a polymerizable group represented by any one of Formula (Ia) to (Ic), and at least one represents a polymerizable group represented by any one of Formula (Id) to (Ij),
L¹ to L⁵ each independently represent a single bond or an alkylene group having 1 to 20 carbon atoms; in the alkylene group having 1 to 20 carbon atoms, at least one —CH₂— may be substituted with —O—, —S—, —NR^{X1}—, or —CO—, at least one —(CH₂)₂— may be substituted with —CH═CH— or —C≡C—, and at least one hydrogen atom bonded to a carbon atom may be substituted with a fluorine atom or a chlorine atom, R^{X1} represents a hydrogen atom, an alkyl group having 1 to 15 carbon atoms, or a group represented by —(CH₂)ₙ—R^{X2}, in the alkyl group having 1 to 15 carbon atoms and the group represented by —(CH₂)ₙ—R^{X2}, at least one —CH₂— may be substituted with —O—, —S—, —NR^{X3}—, or —CO—, at least one —(CH₂)₂— may be substituted with —CH═CH— or —C≡C—, and at least one hydrogen atom bonded to a carbon atom may be substituted with a fluorine atom or a chlorine atom, R^{X2} represents a hydrogen atom or an alkyl group having 1 to 15 carbon atoms, R^{X3} represents a polymerizable group represented by any one of Formulae (Ia) to (Ij), n represents an integer of 0 to 6,
A¹ to A³ each independently represent an aromatic ring group which may have a substituent or a non-aromatic ring group which may have a substituent,
Z¹ to Z⁴ each independently represent —O—, —S—, —OCH₂—, —CH₂CH₂—, —CO—, —COO—, —CO—S—, —O—CO—O—, —CO—NH—, —SCH₂—, —CF₂O—, —CF₂S—,—CH═CH—COO—, —CH═CH—OCO—, —COO—CH₂CH₂—, —OCO—CH₂CH₂—, —COO—CH₂—, —OCO—CH₂—, —CH═CH—, —N═N—, —CH═N—N═CH—, —CH═N—, —CF═CF—, —C≡C—, —C≡C—C≡C—, —OCH₂CH₂O—, —SCH₂CH₂S—, or a single bond,
a and b each independently represent an integer of 0 to 8, and 3≤a+b≤8, e to g each independently represent an integer of 0 to 3,
here, in Formula (I), 3≤c+d+E+f+G is satisfied,
in a case where X¹ is a hydrogen atom, c represents 0; and in a case where X¹ represents a group represented by *-L¹-P¹, c represents 1, in a case where X² is a hydrogen atom, d represents 0; and in a case where X² represents a group represented by *-L²-P², d represents 1, in a case where a represents 0, E represents 0; in a case where a represents 1, E represents a numerical value of e; and in a case where a represents an integer of 2 to 8, E represents a total numerical value of a plurality of e's, in a case where b represents 0, G represents 0; in a case where b represents 1, G represents a numerical value of g; and in a case where b represents an integer of 2 to 8, G represents a total numerical value of a plurality of b's,
in a case where a represents an integer of 2 to 8, a plurality of Z¹'s may be the same or different from each other, and a plurality of (A¹-(L³-P³)ₑ)'s may be the same or different from each other, in a case where e represents an integer of 2 or 3, a plurality of L³'s may be the same or different from each other, and a plurality of P³'s may be the same or different from each other, in a case where b represents an integer of 2 to 8, a plurality of Z⁴'s may be the same or different from each other, and a plurality of (A³-(L⁵-P⁵)_{g})'s may be the same or different from each other, in a case where g represents an integer of 2 or 3, a plurality of L⁵'s may be the same or different from each other, and a plurality of P⁵'s may be the same or different from each other, in a case where f represents an integer of 2 or 3, a plurality of L⁴'s may be the same or different from each other, and a plurality of P⁴'s may be the same or different from each other.

In Formula (I), X¹'s each independently represent a hydrogen atom or a group represented by *-L¹-P¹. X²'s each independently represent a hydrogen atom or a group represented by *-L²-P². * represents a bonding position.

L¹, L², P¹, and P² are as described later.

As X¹, the group represented by *-L¹-P¹ is preferable.

As X², the group represented by *-L²-P² is preferable.

In Formula (I), P¹ to P⁵ each independently represent a polymerizable group represented by any one of Formulae (Ia) to (Ij). among the groups included in the liquid crystal compound represented by Formula (I) as any of P¹ to P⁵, at least one represents a polymerizable group represented by any one of Formula (Ia) to (Ic) (hereinafter, also referred to as “polymerizable group E”), and at least one represents a polymerizable group represented by any one of Formula (Id) to (Ij) (hereinafter, also referred to as “polymerizable group R”).

That is, in the specific liquid crystal compound, at least one of the groups included in any of P¹ to P⁵ represents the polymerizable group E, and at least one thereof represents the polymerizable group R. Specifically, in a case where a is 0, b is 3, f and g are 1, X¹ is the group represented by *-L¹-P¹, and X² is the group represented by *-L²-P², the specific liquid crystal compound does not have P³, and thus at least one of the groups as any of P¹, P², P⁴, or P⁵ represents the polymerizable group E, and at least one thereof represents the polymerizable group R.

It is preferable that, among P¹ to P⁵, at least two of P¹ to P⁵ represent the polymerizable group E and at least two of P¹ to P⁵ represent the polymerizable group R.

In addition, from the viewpoint that the effect of the present invention is more excellent, the polymerizable group E is preferably a polymerizable group represented by Formula (Ia). From the viewpoint that the effect of the present invention is more excellent, the polymerizable group R is preferably a polymerizable group represented by Formula (Id).

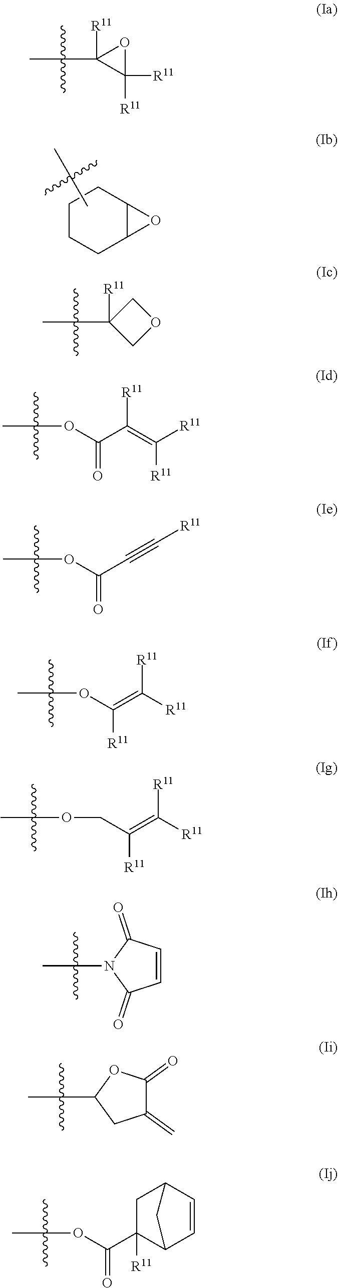

In Formulae (Ia) to (Ij), a broken line represents a bonding position, R^{I1} represents a hydrogen atom or an alkyl group having 1 to 15 carbon atoms, in the alkyl group having 1 to 15 carbon atoms, at least one —CH₂— may be substituted with —O—, —S—, —NR^{I2}—, or —CO—, at least one —(CH₂)₂— may be substituted with —CH═CH— or —C≡C—, and at least one hydrogen atom bonded to a carbon atom may be substituted with a fluorine atom or a chlorine atom, and R^{I2} represents a hydrogen atom or an alkyl group having 1 to 14 carbon atoms.

The bonding position represented by the broken line means, for example, the following bonding mode in a case where P¹ is the group represented by Formula (Ia). In a case where a represents 0, * represents a bonding position with Z²; and in a case where a represents an integer of 1 to 8, * represents a bonding position with Z¹.

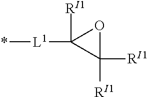

The above-described alkyl group represented by R^{I1} may be linear, branched, or cyclic, and is preferably linear or branched, and more preferably linear.

In addition, in a case where the above-described alkyl group represented by R^{I1} has a structure in which at least one —CH₂— is substituted with —O—, —S—, —NR^{I2}, or —CO—, the number of carbon atoms in the alkyl group means the number of carbon atoms counted by the method shown below.

In the above-described alkyl group represented by R^{I1}, in a case where the alkyl group has a structure in which —CH₂— is substituted with —O—, —S—, or —CO—, the number of carbon atoms in the alkyl group means the number of carbon atoms counted by regarding —O—, —S—, or —CO— introduced instead of —CH₂— as —CH₂—. That is, for example, in a case where R^{I1} is a group represented by —CH₂—CO—O—C₄H₁₀, the number of carbon atoms in this group is 7.

In the above-described alkyl group represented by R^{I1}, in a case where the alkyl group has a structure in which —CH₂— is substituted with —NR^{I2}—, the number of carbon atoms in the alkyl group means the number of carbon atoms counted by regarding —NR^{I2}— introduced instead of —CH₂— as —CHR^{I2}—. That is, for example, in a case where R^{I1} is a group represented by —CH₂—CO—NH—C₄H₁₀, the number of carbon atoms in this group is 7; and for example, in a case where R^{I1} is a group represented by —CH₂—CO—N(CH₃)—C₄H₁₀, the number of carbon atoms in this group is 8.

In addition, in a case where R^{I1} represents an alkyl group having 1 to 15 carbon atoms, in which at least one —CH₂— is substituted with —O—, —S—, —NR^{I2}—, or —CO—, the total number of —O—, —S—, —NR^{I2}—, and —CO— introduced in the alkyl group instead of —CH₂— is preferably 1 to 4 and more preferably 1 or 2.

In addition, in a case where R^{I1} represents an alkyl group having 1 to 15 carbon atoms, in which at least one —CH₂— is substituted with —O—, —S—, —NR^{I2}—, or —CO—, the introduction position of —O—, —S—, —NR^{I2}—, or —CO— introduced in the alkyl group instead of —CH₂— is not particularly limited, and for example, it may be a position adjacent to a constituent carbon of an epoxy group specified in Formula (Ia) or a position adjacent to a constituent carbon of an oxetane group specified in Formula (Ic), or it may be any other position.

In addition, in a case where R^{I1} represents an alkyl group having 1 to 15 carbon atoms, in which at least one —CH₂— is substituted with —O—, —S—, —NR^{I2}—, or —CO—, adjacent —CH₂—'s in the alkyl group may be each substituted with a group selected from —O—, —S—, —NR^{I2}—, and —CO—. That is, R^{I1} may be, for example, an alkyl group having 1 to 15 carbon atoms, which is substituted with —CO—O— or the like.

In addition, in a case where R^{I1} represents an alkyl group having 1 to 15 carbon atoms, in which at least one —(CH₂)₂— is substituted with —CH═CH— or —C≡C—, the total number of —CH═CH— and —C≡C— introduced in the alkyl group instead of —(CH₂)₂— is preferably 1 to 4 and more preferably 1 or 2.

In addition, in a case where R^{I1} represents an alkyl group having 1 to 15 carbon atoms, in which at least one —(CH₂)₂— is substituted with —CH═CH— or —C≡C—, the introduction position of —CH═CH— or —C≡C— introduced in the alkyl group instead of —(CH₂)₂— may be a position adjacent to the constituent carbon of the epoxy group specified in Formula (Ia) and a position adjacent to the constituent carbon of the oxetane group specified in Formula (Ic), or may be any other position.

In addition, in R^{I1}, at least one of hydrogen atoms bonded to the carbon atoms may be substituted with a fluorine atom or a chlorine atom. All hydrogen atoms bonded to the carbon atoms may be substituted with a fluorine atom or a chlorine atom.

R^{I2} is preferably a hydrogen atom or an alkyl group having 1 to 12 carbon atoms, more preferably a hydrogen atom or an alkyl group having 1 to 6 carbon atoms, and still more preferably a hydrogen atom or an alkyl group having 1 to 3 carbon atoms.

R^{I1} is preferably a hydrogen atom or an alkyl group having 1 to 12 carbon atoms, more preferably a hydrogen atom or an alkyl group having 1 to 8 carbon atoms, still more preferably a hydrogen atom or an alkyl group having 1 to 6 carbon atoms, and particularly preferably a hydrogen atom or an alkyl group having 1 to 3 carbon atoms.

In Formula (I), L¹ to L⁵ each independently represent a single bond or an alkylene group having 1 to 20 carbon atoms. In the alkylene group having 1 to 20 carbon atoms, at least one —CH₂— may be substituted with —O—, —S—,—NR^{X1}—, or —CO—, at least one —(CH₂)₂— may be substituted with —CH═CH— or —C≡C—, and at least one hydrogen atom bonded to a carbon atom may be substituted with a fluorine atom or a chlorine atom.

The above-described alkylene group represented by L¹ to L⁵ may be linear, branched, or cyclic, and is preferably linear or branched, and more preferably linear.

In addition, a method for counting the number of carbon atoms in the above-described alkylene group represented by L¹ to L⁵ is the same as the method for counting the number of carbon atoms in the alkyl group represented by R^{I1} described above.

For example, in a case where the above-described alkylene group is a group represented by —CH₂—CO—O—CH₂—, the number of carbon atoms in this group is 4. In a case where the above-described alkylene group is a group represented by —CO—NH—C₄H₈—, the number of carbon atoms in this group is 6; and in a case where the above-described alkylene group is a group represented by —CO—N(CH₃)—C₄H₈—, the number of carbon atoms in this group is 7. In a case where the above-described alkylene group is represented by —CO—N(CH₂—C₂H₃O)—CH₂—, the number of carbon atoms in this group is 7 (with the oxygen atom in the group of —C₂H₃O, the number of carbon atoms is counted by regarding —O— introduced instead of —CH₂— as —CH₂—).

In addition, in a case where L¹ to L⁵ represent an alkyl group having 1 to 20 carbon atoms, in which at least one —CH₂— is substituted with —O—, —S—, —NR^{X1}—, or —CO—, the total number of —O—, —S—, —NR^{X1}—, and —CO— introduced in the alkyl group instead of —CH₂— is preferably 1 to 4 and more preferably 1 or 2.

In addition, in a case where L¹ to L⁵ represent an alkylene group having 1 to 20 carbon atoms, in which at least one —CH₂— is substituted with —O—, —S—, —NR^{X1}—, or —CO—, the introduction position of —O—, —S—, —NR^{X1}—, or —CO— introduced in the alkylene group instead of —CH₂— may be any of a position adjacent to a position adjacent to the polymerizable group represented by P¹ to P⁵, a position adjacent to a bonding position different from the polymerizable group side represented by P¹ to P⁵, or any other position.

In addition, in a case where L¹ to L⁵ represent an alkylene group having 1 to 20 carbon atoms, in which at least one —CH₂— is substituted with —O—, —S—, —NR^{X1}—, or —CO—, adjacent —CH₂—'s in the alkylene group may be each substituted with a group selected from —O—, —S—, —NR^{X1}—, and —CO—. That is, L¹ to L⁵ may be, for example, an alkylene group having 1 to 20 carbon atoms, which is substituted with —CO—O— or the like.

In addition, in a case where L¹ to L⁵ represent an alkylene group having 1 to 20 carbon atoms, in which at least one —(CH₂)₂— is substituted with —CH═CH— or —C≡C—, the total number of —CH═CH— and —C≡C— introduced in the alkylene group instead of —(CH₂)₂— is preferably 1 to 4 and more preferably 1 or 2.

In addition, in a case where L¹ to L⁵ represent an alkylene group having 1 to 20 carbon atoms, in which at least one —(CH₂)₂— is substituted with —CH═CH— or —C≡C—, the introduction position of —CH═CH— or —C≡C— introduced in the alkylene group instead of —(CH₂)₂— may be any of a position adjacent to the polymerizable group represented by P¹ to P⁵, a position adjacent to a bonding position different from the polymerizable group side represented by P¹ to P⁵, or any other position.

In addition, in L¹ to L⁵, at least one of hydrogen atoms bonded to the carbon atoms may be substituted with a fluorine atom or a chlorine atom. All hydrogen atoms bonded to the carbon atoms may be substituted with a fluorine atom or a chlorine atom.

As the alkyl group having 1 to 15 carbon atoms, represented by R^{X1}, the above-described alkyl group having 1 to 15 carbon atoms, represented by R^{I1}, is preferable.

R^{X2} in the group represented by —(CH₂)ₙ—R^{X2} as R^{X1} is preferably a hydrogen atom or an alkyl group having 1 to 12 carbon atoms, more preferably a hydrogen atom or an alkyl group having 1 to 6 carbon atoms, and still more preferably a hydrogen atom or an alkyl group having 1 to 3 carbon atoms.
n represents an integer of 0 to 6, and is preferably an integer of 1 to 3, more preferably 1 or 2, and still more preferably 1.

In addition, in the group represented by —(CH₂)ₙ—R^{X2}, the aspect in which at least one —CH₂— is substituted with —O—, —S—, —NR¹²—, or —CO— and the aspect in which at least one —(CH₂)₂— is substituted with —CH═CH— or —C≡C— are the same as in the above-described alkyl group having 1 to 15 carbon atoms, represented by R^{I1}.

R^{X3} represents the polymerizable group represented by any one of Formulae (Ia) to (Ij) described above, and is preferably the polymerizable group represented by Formula (Ia) or the polymerizable group represented by Formula (Id).

From the viewpoint that the effect of the present invention is more excellent, L¹ to L⁵ are each preferably the above-described alkylene group having 1 to 20 carbon atoms, and more preferably an alkylene group having 1 to 20 carbon atoms, in which at least one —CH₂— may be substituted with —O— or —CO—. In addition, the hydrogen atom in the above-described alkylene group may be substituted with a fluorine atom.

In addition, L¹ and L² are each preferably an alkylene group having 1 to 20 carbon atoms.

From the viewpoint that the effect of the present invention is more excellent and viewpoint that a phase transition temperature of liquid crystal phase—isotropic phase (Iso) of the specific liquid crystal compound is higher, the upper limit value of the number of carbon atoms in the above-described alkylene group having 1 to 20 carbon atoms in L¹ and L² is preferably 12 or less, more preferably 10 or less, still more preferably 8 or less, particularly preferably 7 or less, and most preferably 6 or less. From the viewpoint that the effect of the present invention is more excellent and viewpoint that a melting point of the specific liquid crystal compound is lower, the lower limit value thereof is preferably 2 or more, and more preferably 3 or more.

From the viewpoint that the effect of the present invention is more excellent and viewpoint that a phase transition temperature of liquid crystal phase—isotropic phase (Iso) of the specific liquid crystal compound is higher, the upper limit value of the number of carbon atoms in the above-described alkylene group having 1 to 20 carbon atoms in L³ to L⁵ is preferably 12 or less, more preferably 10 or less, still more preferably 8 or less, particularly preferably 5 or less, and most preferably 4 or less. The lower limit value thereof is preferably 1 or more.

Among these, From the viewpoint that the effect of the present invention is more excellent, viewpoint that a phase transition temperature of liquid crystal phase—isotropic phase (Iso) of the specific liquid crystal compound is higher, and viewpoint that a melting point of the specific liquid crystal compound is lower, the number of carbon atoms in the above-described alkylene group having 1 to 20 carbon atoms in L³ to L⁵ is preferably 1 to 5 and more preferably 1 to 4.

Examples of L¹ to L⁵ include —O—CH₂—, —O—CH₂CH₂—, —O—CH₂CH₂CH₂—, —O—CH₂CH₂CH₂CH₂—, —O—CH₂CH₂OCH₂—, —O—CH₂CH₂CH₂CH₂CH₂—,—O—CH₂CH₂CH₂OCH₂—, —O—CH₂CH₂CH₂CH₂CH₂CH₂—, —O—CH₂CH₂CH₂CH₂OCH₂—, —COO—CH₂—, —COO—CH₂CH₂—, —COO—CH₂CH₂CH₂—,—COO—CH₂CH₂CH₂CH₂—, —OCO—CH₂CH₂OCH₂—, and —CONR^{X1}—CH₂—. R^{X1} is as described above.

In Formula (I), A¹ to A³ each independently represent an aromatic ring group which may have a substituent or a non-aromatic ring group which may have a substituent.

The above-described aromatic ring group or the above-described non-aromatic ring group, represented by A¹, is a (2+e)-valent aromatic ring group which may have a substituent or a (2+e)-valent non-aromatic ring group which may have a substituent; the above-described aromatic ring group or the above-described non-aromatic ring group, represented by A², is a (2+f)-valent aromatic ring group which may have a substituent or a (2+f)-valent non-aromatic ring group which may have a substituent; and the above-described aromatic ring group or the above-described non-aromatic ring group, represented by A³, is a (2+g)-valent aromatic ring group which may have a substituent or a (2+g)-valent non-aromatic ring group which may have a substituent. For example, the above-described aromatic ring group or the above-described non-aromatic ring group, represented by A¹, is a group formed by removing (2+e) hydrogen atoms from an aromatic ring constituting the aromatic ring group or from a non-aromatic ring constituting the non-aromatic ring group.

The aromatic ring constituting the above-described aromatic ring group and the non-aromatic ring constituting the above-described non-aromatic ring group are each preferably a 5- to 7-membered ring, more preferably a 5-membered ring or a 6-membered ring, and still more preferably a 6-membered ring. The above-described aromatic ring and the above-described non-aromatic ring may be monocyclic or polycyclic, and are preferably monocyclic.

The above-described aromatic ring may be any of an aromatic hydrocarbon ring or an aromatic heterocyclic ring, and from the viewpoint that liquid crystallinity of the specific liquid crystal compound is more excellent, an aromatic hydrocarbon ring is preferable.

Examples of the aromatic hydrocarbon ring include a benzene ring and a naphthalene ring, and a benzene ring is preferable.

A heteroatom included in the aromatic heterocyclic ring is not particularly limited, and examples thereof include a nitrogen atom. The number of heteroatoms included in the aromatic heterocyclic ring is not particularly limited, but is preferably 1 to 4 and more preferably 1 or 2.

Examples of the aromatic heterocyclic ring include a pyridine ring and a pyrimidine ring.

The non-aromatic ring may be any of an aliphatic hydrocarbon ring or an aliphatic heterocyclic ring, and from the viewpoint that liquid crystallinity of the specific liquid crystal compound is more excellent, an aliphatic hydrocarbon ring is preferable.

Examples of the aliphatic hydrocarbon ring include a cyclohexane ring.

A heteroatom included in the aliphatic heterocyclic ring is not particularly limited, and examples thereof include a nitrogen atom. The number of heteroatoms included in the aromatic heterocyclic ring is not particularly limited, but for example, it is preferably 1 to 4 and more preferably 1 or 2.

Examples of the aliphatic heterocyclic ring include a piperazine ring.

From the viewpoint that the liquid crystallinity of the specific liquid crystal compound is more excellent, A¹ to A³ are each preferably an aromatic hydrocarbon ring group which may have a substituent or an aliphatic hydrocarbon ring group which may have a substituent. The above-described aromatic hydrocarbon ring group or the above-described aliphatic hydrocarbon ring group, represented by A¹, is, for example, a group formed by removing (2+e) hydrogen atoms from an aromatic hydrocarbon ring constituting the aromatic hydrocarbon ring group or from an aliphatic hydrocarbon ring constituting the aliphatic hydrocarbon ring group.

As A¹ to A³, a phenylene group which may have a substituent or a cyclohexylene group which may have a substituent is preferable, and a 1,4-phenylene group which may have a substituent or a trans-1,4-cyclohexylene group which may have a substituent is more preferable.

In a case where A¹ is a benzene ring group, the bonding positions with Z¹ and Z² in the benzene ring are preferably at 1,4-positions (para position). In a case where A² is a benzene ring group, the bonding positions with Z² and Z³ in the benzene ring are preferably at 1,4-positions (para position). In a case where A³ is a benzene ring group, the bonding positions with Z³ and Z⁴ in the benzene ring are preferably at 1,4-positions (para position).

In a case where A¹ is a cyclohexane ring group, the bonding positions with Z¹ and Z² in the cyclohexane ring are preferably at trans-1,4 positions (trans-para positions). In a case where A² is a cyclohexane ring group, the bonding positions with Z² and Z³ in the cyclohexane ring are preferably at trans-1,4 positions (trans-para positions). In a case where A³ is a cyclohexane ring group, the bonding positions with Z³ and Z⁴ in the cyclohexane ring are preferably at trans-1,4 positions (trans-para positions).

The substituent which can be included in the above-described aromatic ring group or the above-described non-aromatic ring group means a substituent other than -L³-P³, -L⁴-P⁴ and -L⁵-P⁵ in Formula (I).

Examples of the above-described substituent include a halogen atom, a cyano group, a nitro group, an alkyl group having 1 to 5 carbon atoms, which may be substituted with a halogen atom, an alkoxy group having 1 to 5 carbon atoms, an alkylthio group having 1 to 5 carbon atoms, an acyloxy group having 2 to 6 carbon atoms, an alkoxycarbonyl group having 2 to 6 carbon atoms, a carbamoyl group, an alkyl-substituted carbamoyl group having 2 to 6 carbon atoms, and an acylamino group having 2 to 6 carbon atoms.

In Formula (I), Z¹ to Z⁴ each independently represent —O—, —S—, —OCH₂—, —CH₂CH₂—, —CO—, —COO—, —CO—S—, —O—CO—O—, —CO—NH—, —SCH₂—, —CF₂O—, —CF₂S—, —CH═CH—COO—, —CH═CH—OCO—, —COO—CH₂CH₂—, —OCO—CH₂CH₂—, —COO—CH₂—, —OCO—CH₂—, —CH—CH—, —N═N—, —CH═N—N═CH—, —CH═N—, —CF═CF—, —C≡C—, —C≡C—C≡C—, —OCH₂CH₂O—, —SCH₂CH₂S—, or a single bond.

From the viewpoint that the liquid crystallinity of the specific liquid crystal compound is more excellent, Z¹ to Z⁴ are each preferably —OCH₂—, —CH₂CH₂—, —COO—, —CO—S—, —CO—NH—, —CH═CH—COO—, —CH═CH—, —N═N—, —CH═N—N═CH—, —CH═N—, —C≡C—, or a single bond, more preferably —COO— or a single bond, and still more preferably —COO—.

It is preferable that at least two of Z¹ to Z⁴ represent —COO—, and it is more preferable that Z¹ and Z⁴ represent a single bond and Z² and Z³ represent —COO— (preferably, the carbonyl group is disposed on a bonding position side to A²).

In Formula (I), a and b each independently represent an integer of 0 to 8, and 3≤a+b≤8. e to g each independently represent an integer of 0 to 3.

From the viewpoint that the effect of the present invention is more excellent, a and b are each independently preferably an integer of 1 to 8, more preferably an integer of 1 to 6, still more preferably an integer of 1 to 5, particularly preferably an integer of 1 to 4, and most preferably an integer of 2 to 4.

In addition, from the viewpoint that the effect of the present invention is more excellent, it is preferable that 4≤a+b≤8 is satisfied, it is more preferable that 4≤a+b≤6 is satisfied, and it is still more preferable that a+b=4 is satisfied.
e to g are each independently preferably an integer of 0 to 2, and more preferably 0 or 1.
f is preferably an integer of 0 to 3, more preferably an integer of 0 to 2, still more preferably 0 or 1, and particularly preferably 0.

However, in Formula (I), 3≤c+d+E+f+G is satisfied.
“3≤c+d+E+f+G” means that the total numerical value of c, d, E, f, and G is 3 or more.

In a case where X¹ is a hydrogen atom, c represents 0; and in a case where X¹ represents a group represented by *-L¹-P¹, c represents 1. In a case where X² is a hydrogen atom, d represents 0; and in a case where X² represents a group represented by *-L²-P², d represents 1. In a case where a represents 0, E represents 0; in a case where a represents 1, E represents a numerical value of e; and in a case where a represents an integer of 2 to 8, E represents a total numerical value of a plurality of e's. In a case where b represents 0, G represents 0; in a case where b represents 1, G represents a numerical value of g; and in a case where b represents an integer of 2 to 8, G represents a total numerical value of a plurality of b's.

Hereinafter, E and G will be described with an example. In a case where the specific liquid crystal compound is a compound represented by Formula (IX), E corresponds to the numerical value of one e specified in Formula (IX). In addition, in a case where the specific liquid crystal compound is a compound represented by Formula (IY), E corresponds to the total numerical value of three e′s specified in Formula (IY). The definition of G is also the same as the definition of E.

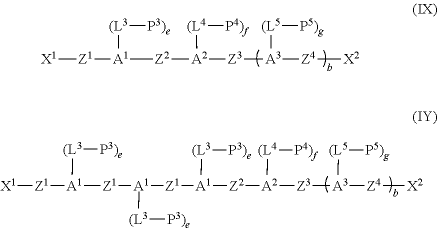

The upper limit value of c+d+E+f+G is preferably 14 or less, more preferably 10 or less, still more preferably 8 or less, and particularly preferably 6 or less. The lower limit value thereof is 3 or more, preferably 4 or more.

Among these, it is preferable that 3≤c+d+E+f+G≤10 is satisfied, it is more preferable that 4≤c+d+E+f+G≤6 is satisfied, and it is still more preferable that c+d+E+f+G=4 is satisfied.

From the viewpoint that the effect of the present invention is more excellent, E and G are each independently preferably an integer of 1 to 4, more preferably an integer of 1 to 3, and still more preferably 1 or 2.

In a case where a represents an integer of 2 to 8, e in the group represented by (L³-P³)ₑ, in which A¹ present on the Z² side among a plurality of A¹'s is substituted, is preferably an integer of 1 to 3 and more preferably 1 or 2. In the above-described aspect, e in the group represented by (L³-P³)ₑ. to be substituted with other A¹ may be an integer of 0 to 3, preferably 0 to 2, and more preferably 0 or 1.

In a case where b represents an integer of 2 to 8, g in the group represented by (L⁵-P⁵)_{g}, in which A³ present on the Z³ side among a plurality of A³'s is substituted, is preferably an integer of 1 to 3 and more preferably 1 or 2. In the above-described aspect, g in the group represented by (L⁵-P⁵)_{g} to be substituted with other A³ may be an integer of 0 to 3, and is preferably 0 to 2 and more preferably 0 or 1.

From the viewpoint that the effect of the present invention is more excellent, the specific liquid crystal compound is preferably a compound represented by Formula (II).

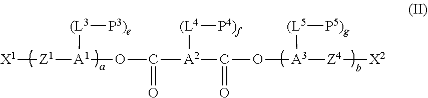

Each of the notations in Formula (II) has the same meaning as each of the notations in Formula (I), and suitable aspects thereof are the same.

From the viewpoint that the effect of the present invention is more excellent, the specific liquid crystal compound is also preferably a compound represented by Formula (III).

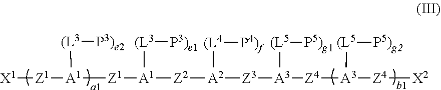

Each of the notations in Formula (III), other than a1, b1, e1, e2, g1, and g2, has the same meaning as each of the notations in Formula (I), and suitable aspects thereof are the same.

In Formula (III), a1 and b1 each independently represent 0 or 1, and 1≤a1+b1≤2. e1 and g1 each independently represent an integer of 1 to 3. e2 and g2 each independently represent an integer of 0 to 2. e1+e2 represents an integer of 0 to 3, and g1+g2 represents an integer of 0 to 3.
It is preferable that a1+b1=2 is satisfied.
e1 and g1 are each independently preferably 1 or 2, and more preferably 1.
e2 and g2 are each independently preferably 0 or 1.
e1+e2 and g1+g2 are preferably 1 or 2, and more preferably 1.

However, in Formula (III), 3≤c+d+e1+e2+f+g1+g2 is satisfied.

“3≤c+d+e1+e2+f+g1+g2” means that the total numerical value of c, d, e1, e2, f, g1, and g2 is 3 or more.

It is preferable that 3≤c+d+e1+e2+f+g1+g2≤10 is satisfied, it is more preferable that 4≤c+d+e1+e2+f+g1+g2≤6 is satisfied, and it is still more preferable that c+d+e1+e2+f+g1+g2=4 is satisfied.

In a case where a1 represents 1, a plurality of Z¹'s may be the same or different from each other, and a plurality of A¹'s may be the same or different from each other.

In a case where el represents 2 or 3 or a case where e2 represents 1 or 2, a plurality of L³'s may be the same or different from each other, and a plurality of P³'s may be the same or different from each other.

In a case where b1 represents 1, a plurality of Z⁴'s may be the same or different from each other, and a plurality of A³'s may be the same or different from each other.

In a case where g1 represents 2 or 3 or a case where g2 represents 1 or 2, a plurality of L⁵'s may be the same or different from each other, and a plurality of P⁵'s may be the same or different from each other.

From the viewpoint that deterioration of smoothness and aligning properties due to precipitation during coating of the liquid crystal layer can be suppressed, an upper limit value of the melting point of the specific liquid crystal compound is preferably 200° C. or lower, more preferably 140° C. or lower, and still more preferably 100° C. or lower. The lower limit value thereof is not particularly limited, but is preferably 50° C. or higher. The melting point of the specific liquid crystal compound can be measured by observing the specific compound under a polarization microscope while heating the specific compound.

A lower limit value of the phase transition temperature of liquid crystal phase—isotropic phase (Iso) of the specific liquid crystal compound is preferably 180° C. or higher, more preferably 200° C. or higher, and still more preferably 220° C. or higher. The upper limit value thereof is not particularly limited, but is preferably 1,000° C. or lower. The phase transition temperature of liquid crystal phase—isotropic phase (Iso) of the specific liquid crystal compound can be measured by observing the specific compound under a polarization microscope while heating the specific compound.

A lower limit value of a molecular weight of the specific liquid crystal compound is preferably 600 or more, more preferably 800 or more, and still more preferably 900 or more. The upper limit value thereof is preferably 2,000 or less, more preferably 1,500 or less, and still more preferably 1,200 or less.

A lower limit value of the total content of the epoxy group and the oxetanyl group in the specific liquid crystal compound (the total number of moles of the epoxy group and the oxetanyl group contained in 1 g of the specific liquid crystal compound) is preferably 2.00 mmol/g or more, and more preferably 3.00 mmol/g or more. The upper limit value thereof is preferably 25.00 mmol/g or less, more preferably 15.00 mmol/g or less, and still more preferably 10.00 mmol/g or less.

Examples of the epoxy group and the oxetanyl group include the above-described polymerizable group E.

A content of the liquid crystal compound in the composition is preferably 60% to 100% by mass, more preferably 70% to 95% by mass, and still more preferably 80% to 90% by mass with respect to the mass of the total solid content of the composition.

### Other Components

The composition may contain a component other than the liquid crystal compound.

### [Curing Agent]

The composition may contain a curing agent. In particular, in a case where the above-described liquid crystal compound has a cationically polymerizable group, the curing agent is preferably a compound having a reactive group capable of a polymerization reaction with the cationically polymerizable group.

Examples of the curing agent include a phenol-based curing agent, an amide-based curing agent, and an active ester-based curing agent, which are described in paragraphs [0095] to [0098] of JP2022-125980A; an amine-based curing agent, a carboxylic acid-based curing agent, an acid anhydride-based curing agent, a polymercaptan-based curing agent, an isocyanate-based curing agent, a blocked isocyanate-based curing agent, and a carbodiimide compound.

The curing agent preferably has a reactive group. The reactive group is not particularly limited, but is preferably a reactive group selected from a phenolic hydroxyl group, an amino group, and a carboxy group, and more preferably a phenolic hydroxyl group.

The number of reactive groups in the curing agent is not particularly limited, but from the viewpoint that the effect of the present invention is more excellent, the lower limit value thereof is preferably 2 or more, and more preferably 3 or more. The upper limit value thereof is preferably 20 or less, more preferably 12 or less, still more preferably 10 or less, and particularly preferably 6 or less.

A lower limit value of a content of the reactive group in the curing agent (a substance amount of the reactive group contained in 1 g of the curing agent) is not particularly limited, but from the viewpoint that the effect of the present invention is more excellent, it is preferably 10 mmol/g or more, more preferably 15 mmol/g or more, and still more preferably 20 mmol/g or more. The upper limit value thereof is preferably 50 mmol/g or less, and more preferably 40 mmol/g or less.

A lower limit value of a molecular weight of the curing agent is preferably 80 or more, and more preferably 100 or more. The upper limit value thereof is preferably 1,000 or less, and more preferably 500 or less.

From the viewpoint that the effect of the present invention is more excellent, the curing agent preferably includes a compound having a phenolic hydroxyl group (hereinafter, also referred to as “phenolic compound”), a compound having an amino group, or a compound having a carboxylic acid group; and more preferably includes a phenolic compound.

As the phenolic compound, a bi- or higher functional phenolic compound (compound having two or more phenolic hydroxyl groups) is preferable, and a bi-to hexafunctional phenolic compound (compound having two to six phenolic hydroxyl groups) is more preferable.

A lower limit value of a hydroxyl number of the phenolic compound is preferably 20 g/mol or more, and more preferably 25 g/mol or more. From the viewpoint that sufficient curing properties can be imparted without disturbing the liquid crystallinity, the upper limit value thereof is preferably 100 g/mol or less, more preferably 67 g/mol or less, and still more preferably 50 g/mol or less.

The phenolic compound is not particularly limited, and a known compound as a phenolic curing agent can be appropriately used. Among these, from the viewpoint that the effect of the present invention is more excellent, the phenolic compound is preferably catechol, resorcinol, phloroglucinol, phloroglucinol carboxylic acid, or a compound represented by Formula (P1).

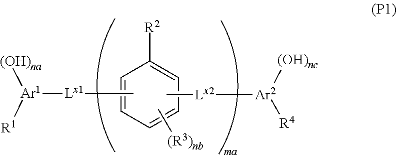

In Formula (P1), ma represents an integer of 0 or more.
ma is preferably 0 to 10, more preferably 0 to 3, still more preferably 0 or 1, and particularly preferably 1.

In General Formula (P1), na and nc each independently represent an integer of 1 or more.
na and nc are preferably 1 to 4, more preferably 2 to 4, still more preferably 2 or 3, and particularly preferably 2.

In Formula (P1), nb represents an integer of 0 to 3.
nb is preferably 0 or 1.

In Formula (P1), in a case where there are a plurality of R²'s, the plurality of R²'s may be the same or different from each other. In a case where there are a plurality of R³'s, the plurality of R³'s may be the same or different from each other. In a case where there are a plurality of L^{X2}'s, the plurality of L^{X2}'s may be the same or different from each other. In a case where there are a plurality of nb's, the plurality of nb's may be the same or different from each other.

In Formula (P1), R¹ and R⁴ each independently represent a hydrogen atom or a substituent.

Examples of the substituent represented by R¹ and R⁴ include a halogen atom, a carboxylic acid group, an amino group, an alkyl group, an alkoxy group, and an alkoxycarbonyl group.

The above-described alkyl group may be linear or branched. The number of carbon atoms in the above-described alkyl group is preferably 1 to 10, more preferably 1 to 6, still more preferably 1 to 3, and particularly preferably 1. In addition, the above-described alkyl group may further have a substituent.

An alkyl group moiety in the above-described alkoxy group and an alkyl group moiety in the above-described alkoxycarbonyl group are the same as the above-described alkyl group.

R¹ and R⁴ are each preferably a hydrogen atom or a halogen atom, more preferably a hydrogen atom or a chlorine atom, and still more preferably a hydrogen atom.

In Formula (P1), R² represents a hydrogen atom or a hydroxyl group.

In a case where there are a plurality of R²'s, it is preferable that at least one R² among the plurality of R²'s represents a hydroxyl group, and it is more preferable that all the R²'s represent a hydroxyl group.

In Formula (P1), Ar¹ and Ar² each independently represent a benzene ring group or a naphthalene ring group.
As Ar¹ and Ar², a benzene ring group is preferable.

In Formula (P1), L^{x1} represents a single bond, —C(R⁵)(R⁶)—, —CO—, —SO₂—, or ═N—N═. L^{x2} represents —C(R⁷)(R⁸)—or —CO—.

Lₓ₁ is preferably —C(R⁵)(R⁶)— or —CO—.

L^{x2} is preferably —C(R⁷)(R⁸)—.

R⁵ to R⁸ each independently represent a hydrogen atom or a substituent.

As the above-described substituent, a hydroxyl group, a halogen atom, a carboxylic acid group, an alkyl group, an alkoxy group, or an alkoxycarbonyl group is preferable; and a hydroxyl group, a halogen atom, a carboxylic acid group, an alkyl group, an alkoxy group, or an alkoxycarbonyl group is more preferable.

The above-described alkyl group may be linear or branched. The number of carbon atoms in the above-described alkyl group is preferably 1 to 10, more preferably 1 to 6, still more preferably 1 to 3, and particularly preferably 1. In addition, the above-described alkyl group may have a substituent. Examples of the substituent include a halogen atom (for example, a fluorine atom).

An alkyl group moiety in the above-described alkoxy group and an alkyl group moiety in the above-described alkoxycarbonyl group are the same as the above-described alkyl group.

As R⁵ to R⁸, a hydrogen atom or a hydroxyl group is preferable, and a hydrogen atom is more preferable.

L^{x1} is preferably —CH₂—, —CH(OH)—, —C(CH₃)₂—, —C(CF₃)₂—, —CO—, —SO₂—, or ═N—N═. L^{x2} is preferably —CH₂—, —CH(OH)—, or —CO—, and more preferably —CH₂—.

Among these, in a case where ma represents 0, L^{x1} is preferably —CH₂—, —CH(OH)—, or —CO—. In a case where ma represents 1, L^{x1} and L^{x2} are each preferably —CH₂—.

In Formula (P1), in a case where there are a plurality of R⁵'s, the plurality of R⁵'s may be the same or different from each other. In a case where there are a plurality of R⁶'s, the plurality of R⁶'s may be the same or different from each other. In a case where there are a plurality of R⁷'s, the plurality of R⁷'s may be the same or different from each other. In a case where there are a plurality of R⁸'s, the plurality of R⁸'s may be the same or different from each other. In Formula (P1), R³ represents a substituent.

Examples of the substituent represented by R³ include an alkyl group, a phenyl group, a halogen atom, a carboxylic acid group, an alkoxy group, and an alkoxycarbonyl group.

The above-described alkyl group may be linear or branched. The number of carbon atoms in the above-described alkyl group is preferably 1 to 10, more preferably 1 to 6, still more preferably 1 to 3, and particularly preferably 1. In addition, the above-described alkyl group may further have a substituent.

An alkyl group moiety in the above-described alkoxy group and an alkyl group moiety in the above-described alkoxycarbonyl group are the same as the above-described alkyl group.

The above-described phenyl group may further have a substituent.

Examples of the compound represented by Formula (P1) include the following compounds.

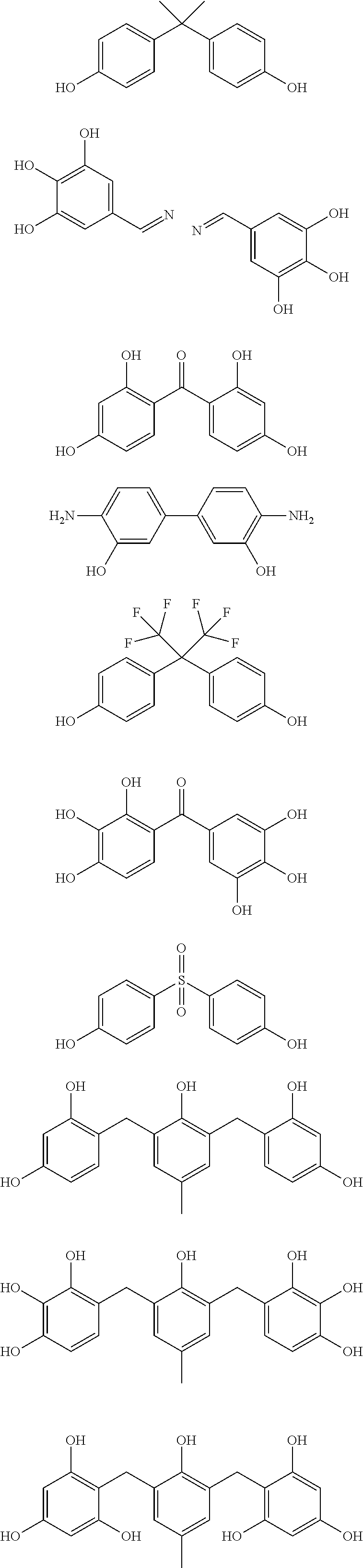

In a case where the composition contains a curing agent, a content of the curing agent is preferably 0.1% to 40% by mass, more preferably 5% to 30% by mass, and still more preferably 10% to 20% by mass with respect to the mass of the total solid content of the composition.

### [Curing Accelerator (Curing Catalyst)]

The composition may further contain a curing accelerator.

The type of the curing accelerator is not limited; and examples thereof include triphenylphosphine, an imidazole-based catalyst, a boron trifluoride amine complex, a tertiary amine, organic phosphines, a phosphonium salt, a tetraphenylborate salt, an organic acid dihydrazide, a halogenated boron amine complex, compounds described in paragraph [0052] of JP2012-067225A, and compounds described in paragraphs [0049] to [0054] of JP2022-125980A.

In a case where the composition contains a curing accelerator, a content of the curing accelerator is preferably 0.5% to 30% by mass, more preferably 1% to 20% by mass, and still more preferably 2% to 15% by mass with respect to the mass of the total solid content of the composition.

### [Ultraviolet Absorber]

The composition may contain an ultraviolet absorber. As will be described later, in a case where the composition contains an ultraviolet absorber, the optically-anisotropic layer can be efficiently manufactured.

Examples of the ultraviolet absorber include a compound selected from the group consisting of a merocyanine-based compound (particularly, a diethylamino-phenylsulfonyl-based ultraviolet absorber), a benzophenone-based compound, a benzoxazinone-based compound, an anthracene-based compound, a benzotriazole-based compound, an indole-based compound, a methine-based compound, a benzodithiol-based compound, and a hydroxyphenyltriazine-based compound.

A wavelength range of ultraviolet rays absorbed by the ultraviolet absorber is not particularly limited, but an ultraviolet absorber having a maximum absorption wavelength in a wavelength range of 300 to 400 nm is suitably used.

In a case where the composition contains an ultraviolet absorber, a content of the ultraviolet absorber is preferably 0.1% to 30% by mass and more preferably 1% to 20% by mass with respect to the mass of the total solid content of the composition.

### [Chiral Agent]

The composition may contain a chiral agent.

In a case where the composition contains a chiral agent, the liquid crystal compound can be twisted and aligned along a helical axis. Such an alignment state is also referred to as a cholesteric alignment.

The type of the chiral agent is not particularly limited. Any known chiral agent (for example, described in “Liquid Crystal Device Handbook” edited by the 142nd Committee of the Japan Society for the Promotion of Science, Chapter 3, 4-3, Chiral agents for TN and STN, p. 199, 1989) can be used.

In a case where the composition contains a chiral agent, a content of the chiral agent is preferably 0.01% to 5.0% by mass, more preferably 0.02% to 3.0% by mass, and still more preferably 0.05% to 2.0% by mass with respect to the total mass of the liquid crystal compound.

### [Polymerization Initiator]

The composition may contain a polymerization initiator.

Examples of a polymerization reaction initiated by the polymerization initiator include a thermal polymerization reaction using a thermal polymerization initiator and a photopolymerization reaction using a photopolymerization initiator, and a photopolymerization reaction is more preferable. Among these, a radical polymerization initiator is preferable.

In a case where the composition contains a polymerization initiator, a content of the polymerization initiator is preferably 0.01% to 20% by mass and more preferably 0.4% to 8% by mass with respect to the total mass of the solid content of the composition.

### [Solvent]

The composition may contain a solvent.

The type of the solvent is not particularly limited, and an organic solvent is preferable. Examples of the organic solvent include cyclopentanone, cyclohexanone, ethyl acetate, methyl ethyl ketone, dichloromethane, and tetrahydrofuran.

In a case where the composition contains a solvent, a content of the solvent is preferably an amount at which the concentration of solid contents in the composition is 1% to 90% by mass, and more preferably an amount at which the concentration of solid contents in the composition is 2% to 85% by mass.

The composition may contain a component other than the above-described components.

Examples of other components include a polyfunctional monomer, an alignment control agent (a vertical alignment agent or a horizontal alignment agent), a surfactant, an adhesion improver, a plasticizer, a polymerization inhibitor, an antioxidant, a light stabilizer, a coloring material, and metal oxide fine particles.

### Manufacturing Method of Optically-Anisotropic Layer

The manufacturing method of the optically-anisotropic layer according to the embodiment of the present invention is not particularly limited.

Among these, from the viewpoint that the optically-anisotropic layer can be efficiently manufactured, a manufacturing method having the step 1 to the step 3 is preferable.

Step 1: a step of forming a coating film using a composition which contains a liquid crystal compound having a polymerizable group, and aligning the liquid crystal compound in the formed coating film

Step 2: a step of polymerizing the liquid crystal compound such that a region where a polymerization rate of the liquid crystal compound continuously changes is formed in a thickness direction of the coating film

Step 3: a step of subjecting the coating film obtained in the step 2 to a heating treatment to form a region where a birefringence index Δn continuously changes in the thickness direction and a wavelength dispersion is constant

Hereinafter, the above steps 1 to 3 will be described in detail.

### (Step 1)

The step 1 is a step of forming a coating film using a composition which contains a liquid crystal compound having a polymerizable group, and aligning the liquid crystal compound in the formed coating film. By carrying out the present step, the coating film containing the aligned liquid crystal compound is formed.

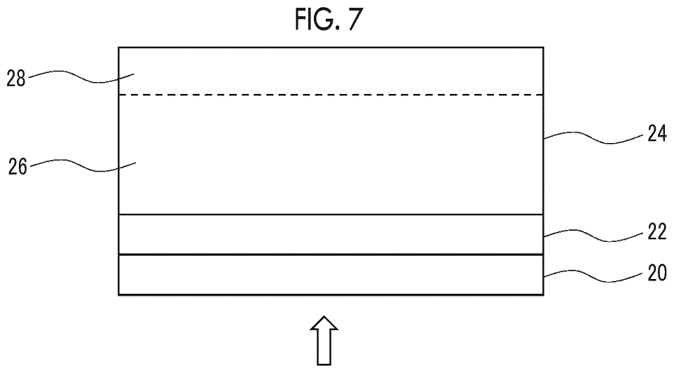

As one suitable embodiment of the present step, it is preferable that the composition is applied onto an alignment film of a support with an alignment film, which has a support and an alignment film, to form a coating film, and the liquid crystal compound in the coating film is aligned. By carrying out the suitable aspect, a laminate including a support 20, an alignment film 22, and a coating film 24 is formed as shown in FIG. 7.

Hereinafter, the procedure of the suitable embodiment will be described in detail. First, the support and the alignment film used in the present step will be described in detail.

The support is a member which supports the th alignment film and the optically-anisotropic layer.

As the support, various sheet-shaped materials (films or plate-shaped materials) can be used as long as the support can support the alignment film and the optically-anisotropic layer.

A transmittance of the support is not particularly limited, but for example, the transmittance of the support to light having a wavelength of 550 nm is preferably 50% or more, more preferably 70% or more, and still more preferably 85% or more.

A thickness of the support is preferably 1 to 1,000 μm, more preferably 3 to 250 μm, and still more preferably 5 to 150 μm.

The support may be single-layered or multi-layered.

In a case where the support has a monolayer structure, examples thereof include supports formed of glass, triacetyl cellulose, polyethylene terephthalate, polycarbonates, polyvinyl chloride, poly (meth)acrylate, polyolefin, and the like. In a case where the support has a multi-layer structure, examples thereof include a support including one of the above-described supports having a monolayer structure, which is provided as a substrate, and another layer which is provided on a surface of the substrate.

The alignment film can be formed by a method such as rubbing treatment of an organic compound (preferably a polymer), oblique vapor deposition of an inorganic compound, formation of a layer having microgrooves, or accumulation of an organic compound (for example, ω-tricosanoic acid, dioctadecylmethylammonium chloride, or methyl stearate) by the Langmuir-Blodgett method (LB film).

Examples of the alignment film include a photo-alignment film.

As a photo-alignment material used for the photo-alignment film, an azo compound, a photocrosslinking polyimide, a photocrosslinking polyamide, a photocrosslinking polyester, a cinnamate compound, or a chalcone compound is suitability used.

A method of forming the photo-alignment film is not particularly limited, and examples thereof include a method of applying a composition for forming a photo-alignment film, containing a predetermined photo-alignment material, onto a surface of the support, drying the composition, and exposing the obtained coating film (precursor of a photo-alignment film) to form an alignment pattern.

In a case of forming the optically-anisotropic layer having the above-described liquid crystal alignment pattern, a photo-alignment film formed using an exposure device for forming the alignment pattern can be used.

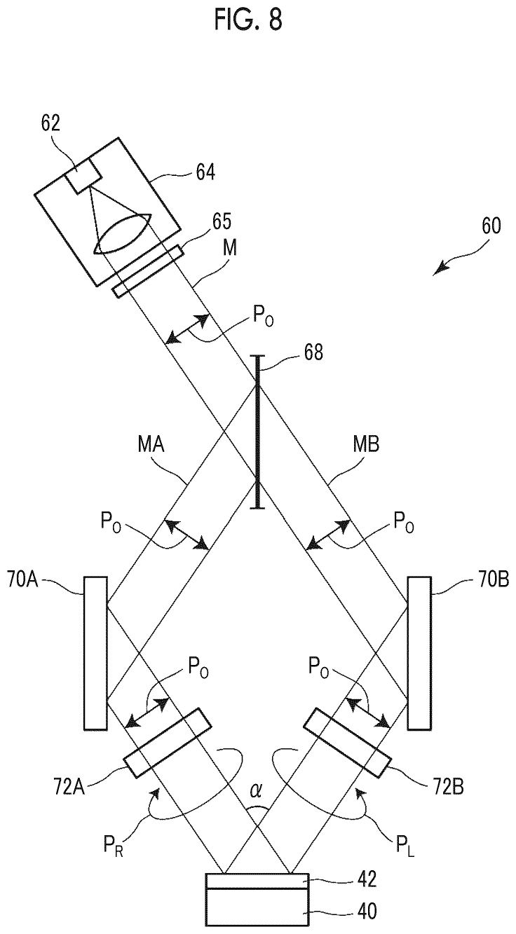

FIG. 8 conceptually shows an example of an exposure device which forms the alignment pattern.

An exposure device 60 shown in FIG. 8 includes a light source 64 including a laser 62, an λ/2 plate 65 which changes a polarization direction of a laser light M emitted from the laser 62, a beam splitter 68 which splits the laser light M emitted from the laser 62 into two beams MA and MB, mirrors 70A and 70B which are each disposed on an optical path of the splitted two beams MA and MB, and λ/4 plates 72A and 72B.

Although not shown in the drawing, the light source 64 emits linearly polarized light P₀. The λ/4 plate 72A converts the linearly polarized light P₀ (ray MA) into dextrorotatory circularly polarized light P_{R}, and the λ/4 plate 72B converts the linearly polarized light P₀ (ray MB) into levorotatory circularly polarized light P_{L}.

The support 40 including the coating film 42 on which the alignment pattern is not yet formed is disposed at an exposed portion, the two rays MA and MB intersect and interfere each other on the coating film 42, and the coating film 42 is irradiated with and exposed to the interference light.

Due to the interference at this time, the polarization state of light with which the coating film 42 is irradiated periodically changes according to interference fringes. As a result, a photo-alignment film having an alignment pattern in which the alignment state periodically changes can be obtained.

In the exposure device 60, by changing an intersecting angle α between the two rays MA and MB, a period of the alignment pattern can be adjusted. That is, by adjusting the intersecting angle α in the exposure device 60, in the alignment pattern in which the orientation of the optical axis derived from the liquid crystal compound continuously rotates in one direction, a length of single period (single period Λ) over which the orientation of the optical axis rotates 180° in the one direction of the rotated orientation of the optical axis can be adjusted.

By forming the optically-anisotropic layer on the photo-alignment film having the alignment pattern in which the alignment state periodically changes, the optically-anisotropic layer having the liquid crystal alignment pattern in which the orientation of the optical axis derived from the liquid crystal compound continuously rotates in the one direction can be formed.

In addition, by rotating the optical axes of the λ/4 plates 72A and 72B by 90°, respectively, the rotation direction of the optical axis can be reversed.

A thickness of the alignment film is not particularly limited as long as it can exhibit an alignment function, but is preferably 0.01 to 5.0 μm, more preferably 0.05 to 3.0 μm, and still more preferably 0.5 to 1.0 μm.

The composition containing a liquid crystal compound having a polymerizable group, which is used in the present step, is as described above.

As the liquid crystal compound used in the present step, a liquid crystal compound having a radically polymerizable group and a cationically polymerizable group is preferable for the reason described later.

For the application of the composition, various known methods used for liquid application, such as bar coating, gravure coating, and spray coating, can be used.

Next, the coating film formed by the application is subjected to an alignment treatment to align the liquid crystal compound. By carrying out the alignment treatment, the liquid crystal compound in the coating film is aligned in a predetermined alignment state according to the alignment pattern of the alignment film.

As the alignment treatment, a heating treatment is preferable. Heating conditions are not particularly limited, and a heating temperature is preferably 50° C. to 140° C. and a heating time is preferably 0.5 to 20 minutes.

### (Step 2)

The step 2 is a step of polymerizing the liquid crystal compound such that a region where a polymerization rate of the liquid crystal compound continuously changes is formed in a thickness direction of the coating film. By carrying out the present step, regions where a degree of curing of the liquid crystal compound is different are formed in the thickness direction of the coating film.

The procedure of the present step is not particularly limited, and examples thereof include a method of forming a coating film using a composition containing an ultraviolet absorber and exposing the formed coating film.

Hereinafter, an example will be described with reference to FIG. 7. In a case where a coating film is formed of a composition containing an ultraviolet absorber, the ultraviolet absorber is present in the coating film in a dispersed manner in the thickness direction. In a case where the coating film is exposed in a direction indicated by a white arrow in FIG. 7, energy of the exposure is strong in a first region 26 on an alignment film 22 side in a coating film 24, and thus the polymerization of the liquid crystal compound sufficiently proceeds. On the other hand, since the energy of the exposure gradually decreases in a depth direction under the influence of the ultraviolet absorber in the coating film 24, a second region 28 on the side of the coating film 24 opposite to the alignment film 22 side is not irradiated with energy to sufficiently advance the polymerization of the liquid crystal compound. Therefore, as a result, in the second region 28, the polymerization rate of the liquid crystal compound continuously decreases in a direction from the alignment film 22 side to a side opposite to the alignment film 22 side.

In the above description, the method of changing the polymerization rate of the liquid crystal compound in the thickness direction of the coating film by gradually decreasing the energy of the exposure in the depth direction of the coating film using the ultraviolet absorber has been described in detail, but the step 2 may be performed by other methods.

In addition, in order to form the above-described region where the polymerization rate of the liquid crystal compound continuously changes, it is preferable to use the liquid crystal compound having a radically polymerizable group and a cationically polymerizable group. By using such a liquid crystal compound, the above-described region can be formed by polymerizing the radically polymerizable group in the step 2, and the cationically polymerizable group can be polymerized in the step 3 described later.

The determination of whether or not the region where the polymerization rate of the liquid crystal compound continuously changes in the thickness direction of the coating film is formed can be performed, for example, by cutting the coating film in the thickness direction, analyzing a cross section of the exposed coating film by infrared absorption spectroscopy or the like, and calculating a residual rate of the polymerizable group in the thickness direction of the coating film.

In the method of forming the coating film using the above-described composition containing an ultraviolet absorber and exposing the formed coating film, an ultraviolet irradiating treatment is preferable as the exposure treatment.

Conditions of the ultraviolet irradiating treatment are appropriately selected depending on the coating film to be used, and an irradiation amount is preferably 0.1 to 1,000 mJ/cm² and more preferably 1 to 300 mJ/cm².

The ultraviolet irradiating treatment is preferably carried out in an atmosphere with a low oxygen concentration. The ultraviolet irradiating treatment is preferably carried out in a nitrogen atmosphere.

### (Step 3)

The step 3 is a step of subjecting the coating film obtained in the step 2 to a heating treatment to form a region where a birefringence index Δn continuously changes in the thickness direction and a wavelength dispersion is constant. By carrying out the present step, the above-described specific region is formed.

The coating film obtained in the step 2 includes a region where the polymerization rate of the liquid crystal compound continuously changes in the thickness direction of the coating film. In a case where the coating film including such a region is subjected to a heating treatment, the alignment state of the liquid crystal compound is maintained in a region where the polymerization rate of the liquid crystal compound is high. On the other hand, in a region where the polymerization rate of the liquid crystal compound is low, the alignment state of the liquid crystal compound cannot be maintained by the heating treatment, and thus disorder of the alignment of the liquid crystal compound occurs. In a case where the disorder of the alignment of the liquid crystal compound occurs, the birefringence index Δn in the region decreases. That is, by carrying out the present step, the region where the polymerization rate of the liquid crystal compound is high is to be a region where the birefringence index Δn is high, and the region where the polymerization rate of the liquid crystal compound is low is to be a region where the birefringence index Δn is low.

In particular, in a case where the liquid crystal compound having a radically polymerizable group and a cationically polymerizable group is used as the liquid crystal compound, the above-described specific region is easily formed. As described above, in a case where the step 2 is performed using the liquid crystal compound having a radically polymerizable group and a cationically polymerizable group, the cationically polymerizable group can remain in the coating film. In a case where the heating treatment is carried out on the coating film in which the cationically polymerizable group remains, the polymerization of the cationically polymerizable group proceeds, the phase transition temperature of liquid crystal phase—isotropic phase (Iso) gradually decreases, and the birefringence index Δn also gradually decreases. Therefore, by selecting a predetermined heating temperature and time, it is easy to form the region where the birefringence index Δn continuously changes.

On the other hand, in a case where the heating treatment is carried out on the coating film in which the cationically polymerizable group is not remaining, the birefringence index Δn is likely to change rapidly due to the heating treatment, and it is difficult to form a predetermined specific region.

In addition, in the step 1 to the step 3, since the specific region can be formed using only the predetermined liquid crystal compound, the wavelength dispersion in the specific region is constant.

Conditions of the heating treatment carried out in the present step are not particularly limited, and optimal conditions are selected according to the coating film to be used. A heating temperature during the heating treatment is preferably 50° C. to 300° C. and more preferably 100° C. to 200° C. A heating time at the heating temperature is preferably 0.5 to 30 minutes and more preferably 1 to 5 minutes. In addition, from the viewpoint that Δn of the liquid crystal compound can be changed significantly, the heating temperature is preferably equal to or higher than the phase transition temperature of liquid crystal phase—isotropic phase (Iso) of the liquid crystal compound.

After the step 3 is performed, a step 4 of subjecting the optically-anisotropic layer obtained in the step 3 to an exposure treatment may be performed. By carrying out the exposure treatment, the unreacted polymerizable group can be polymerized. In particular, in a case where the liquid crystal compound having a radically polymerizable group and a cationically polymerizable group is used, the radically polymerizable group which has not reacted in the step 2 can be polymerized by performing the step 4.

As the exposure treatment, an ultraviolet irradiating treatment is preferable.

Conditions of the ultraviolet irradiating treatment are appropriately selected according to the coating film to be used, and an irradiation amount is preferably 50 to 2,000 mJ/cm² and more preferably 100 to 1,500 mJ/cm².

The ultraviolet irradiating treatment is preferably carried out in an atmosphere with a low oxygen concentration. The ultraviolet irradiating treatment is preferably carried out in a nitrogen atmosphere.

### Applications

The optically-anisotropic layer according to the embodiment of the present invention can be adopted to various applications. For example, the optically-anisotropic layer according to the embodiment of the present invention can be used as a so-called λ/4 plate or λ/2 plate by adjusting the in-plane retardation of the optically-anisotropic layer.

The λ/4 plate is a plate having a function of converting linearly polarized light having a specific wavelength into circularly polarized light (or converting circularly polarized light into linearly polarized light). More specifically, the λ/4 plate is a plate in which the in-plane retardation Re at a predetermined wavelength λnm is λ/4 (or an odd multiple thereof).

An in-plane retardation (Re(550)) of the λ/4 plate at a wavelength of 550 nm may have an error of approximately 25 nm based on an ideal value (137.5 nm), and is, for example, preferably 110 to 160 nm and more preferably 120 to 150 nm.

In addition, the λ/2 plate refers to an optically anisotropic film in which an in-plane retardation Re(λ) at a specific wavelength of λnm satisfies Re(λ)≈λ/2. This expression may be achieved at any wavelength (for example, 550 nm) in the visible light region. Among these, it is preferable that the in-plane retardation Re(550) at a wavelength of 550 nm satisfies the following relationship.
210 nm≤Re(550)≤300 nm

In addition, in a case where the optically-anisotropic layer has the above-described liquid crystal alignment pattern, the optically-anisotropic layer according to the embodiment of the present invention can also be used as a liquid crystal diffraction element.

### EXAMPLES

Hereinafter, the present invention will be described in more detail based on Examples. The materials, the amounts of materials used, the proportions, the treatment details, the treatment procedure, and the like shown in Examples below may be appropriately modified as long as the modifications do not depart from the spirit of the present invention. Therefore, the scope of the present invention should not be construed as being limited to Examples shown below.

### Synthesis of Polymerizable Liquid Crystal Compound LC1

A synthesis route of a polymerizable liquid crystal compound LC1 is shown below.

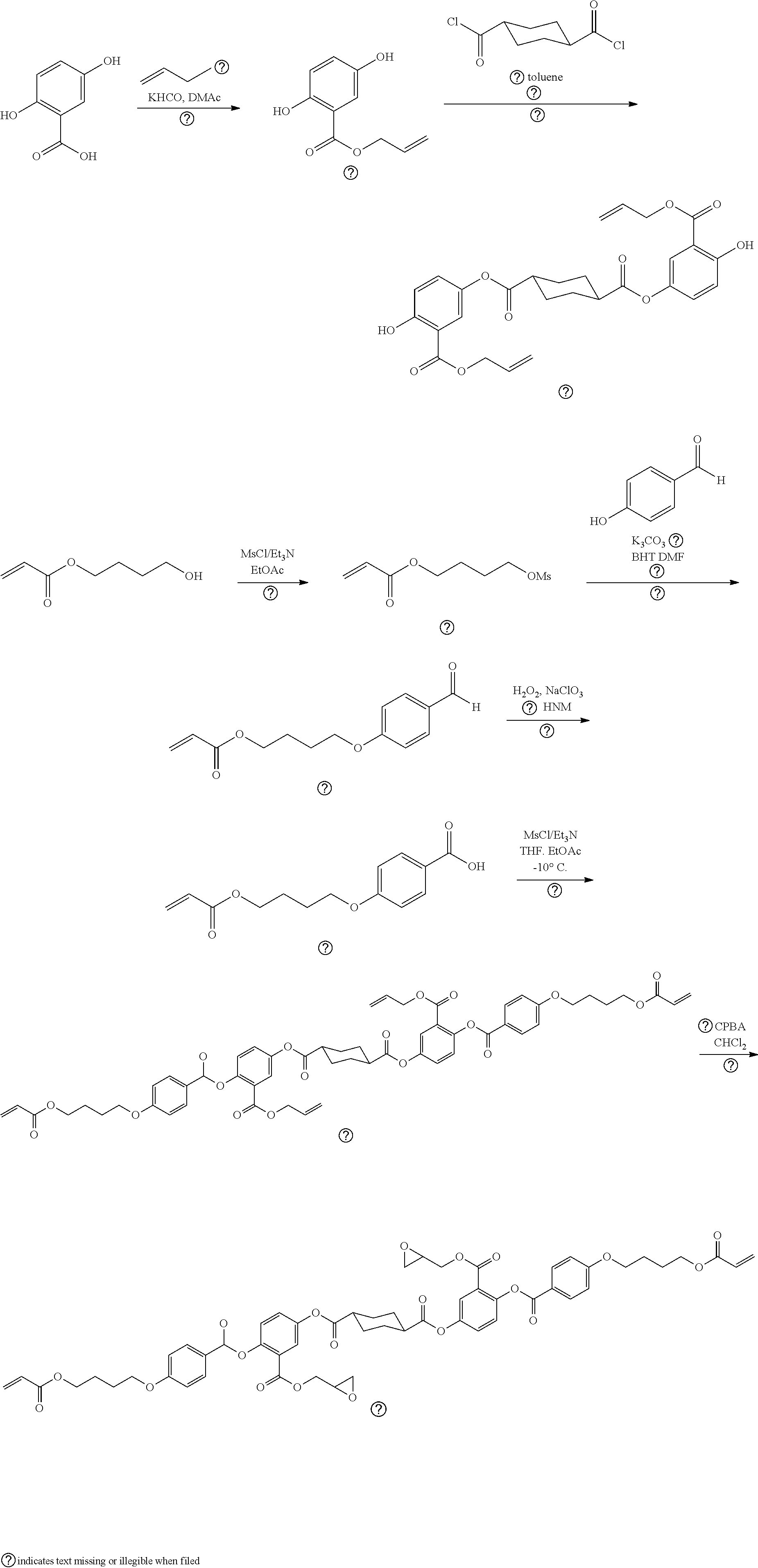

### Synthesis of Compound LC1A

Glycine (50.0 g), allyl bromide (43.2 g), and potassium hydrogen carbonate (39.0 g) were stirred in N,N-dimethylacetamide (250 mL) at 60° C. for 3 hours. 1 N hydrochloric acid water and ethyl acetate were added thereto to remove the water phase, and the organic phase was washed in the order of 1 N hydrochloric acid water, sodium bicarbonate water, and saline. The organic layer was dried over magnesium sulfate, the magnesium sulfate was filtered, and then the solvent was distilled off under reduced pressure to obtain a compound LCIA (60.3 g).

### Synthesis of Compound LC1B

A t-1,4-cyclohexanedicarboxylic acid chloride (2.0 g), the compound LC1A (4.1 g), and methanesulfonic acid chloride (0.06 g) were stirred in toluene (35 mL) and ethyl acetate (1.5 mL) at 90° C. for 2 hours. Subsequently, the mixture was cooled to room temperature, methanol (150 mL) was added thereto, the mixture was stirred for 30 minutes, and the resulting crystals were filtered to obtain a compound LC1B (3.5 g).

### Synthesis of Compound LC1C to Compound LC1E

Compounds LC1C to LC1E were synthesized with reference to WO2022/190936A.

### Synthesis of Compound LC1F

Methanesulfonyl chloride (1.77 g) was stirred in tetrahydrofuran (6.9 mL) and ethyl acetate (9.7 ml), and a tetrahydrofuran (6.9 ml) solution of LC1E (4.0 g) and triethylamine (1.64 g) was added dropwise thereto at −10° C. and stirred for 1 hour. Subsequently, N-methylimidazole (0.017 g), LC1B (3.69 g), and triethylamine (1.78 g) were each added dropwise thereto at 5° C., and the mixture was stirred at room temperature for 2 hours. Furthermore, 4 mL of pure water and 60 mL of methanol were added thereto, the mixture was cooled to 0° C. and stirred for 1 hour, and the produced crystals were filtered, washed with methanol, and then blast-dried at 40° C. for 24 hours to obtain a compound LCIF (5.3 g).

### Synthesis of Polymerizable Liquid Crystal Compound LC1

The compound LCIF (4.0 g) and m-chloroperoxybenzoic acid (5.82 g) were stirred in chloroform (40 mL) at 50° C. for 7 hours. Subsequently, an aqueous solution of 5% by mass sodium hydrogen sulfite was added thereto to remove the water phase, and the organic phase was washed in the order of sodium hydrogen carbonate water and saline. The organic phase was dried over magnesium sulfate, filtered off the magnesium sulfate, and then purified by silica gel chromatography to obtain a polymerizable liquid crystal compound LC1 (1.5 g).

¹H-NMR (400 MHZ, CDCl₃) of polymerizable liquid crystal compound LC1: 8.16 (4H, d), 7.81 (2H, d), 7.37 (2H, dd), 7.27 to 7.25 (2H, d), 7.01 to 6.95 (4H, m), 6.42 (2H, dd), 6.13 (2H, dd), 5.84 (2H, dd), 4.39 (2H, dd), 4.28 to 4.23 (4H, m), 4.12 to 4.05 (6H, m), 3.12 to 3.07 (2H, m), 2.72 (2H, dd), 2.68 to 2.60 (2H, m), 2.54 (2H, dd), 2.35 to 2.31 (4H, m), 1.86 to 1.98 (8H, m), 1.78 to 1.65 (4H, m)

### Example 1

### Formation of Alignment Film

A quartz glass substrate was prepared as a support (first support). A composition “SE-130” (manufactured by Nissan Chemical Corporation) for forming a polyimide alignment film was applied onto the support to form a coating film. After firing the obtained coating film, the coating film was subjected to a rubbing treatment to produce a substrate with an alignment film.

### Formation of Optically-Anisotropic Layer H-1

As a composition for forming an optically-anisotropic layer, the following composition HL-1 was prepared.

Composition HL-1

| | | |
|---|---|---|
| Polymerizable liquid crystal compound LC1 | 93.0 | parts by mass |
| Phloroglucinol (manufactured by Tokyo | 7.0 | parts by mass |
| Chemical Industry Co., Ltd.) | | |
| Triphenylphosphine (manufactured by Tokyo | 3.0 | parts by mass |
| Chemical Industry Co., Ltd.) | | |
| UV agent 1 (manufactured by Sigma-Aldrich | 5.0 | parts by mass |
| Co., LLC) | | |
| Polymerization initiator (manufactured | 4.0 | parts by mass |
| by BASF, Omnirad OXE01) | | |
| Leveling agent T-1 | 0.1 | parts by mass |
| Tetrahydrofuran | 213 | parts by mass |
| Dichloromethane | 638 | parts by mass |

UV agent 1: Octyl (2Z,4E)-5-(diethylamino)-2-(phenylsulfonyl)penta-2,4-dienoate

### Leveling Agent T-1 (See Structural Formula Below)

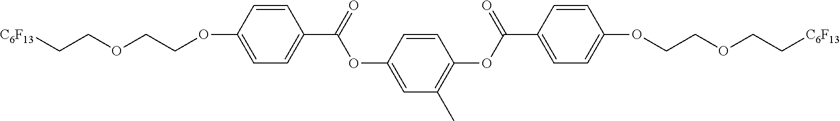

The composition HL-1 was applied onto the alignment film of the prepared substrate with an alignment film by spin coating under the conditions of 1,000 rpm and 10 seconds to form a coating film, and the coating film was heated at 90° C. for 1 minute (step 1).

Subsequently, the coating film was cooled to 30° C., and the coating film was irradiated with ultraviolet rays having a wavelength of 365 nm at an irradiation amount of 2 mJ/cm² from the quartz glass substrate side using a 365 nm LED UV exposure machine in a nitrogen atmosphere (step 2).

Subsequently, the coating film irradiated with light was heated at 155° C. for 3 minutes in a nitrogen atmosphere (step 3).

Subsequently, the coating film was irradiated with ultraviolet rays having a wavelength of 365 nm at an irradiation amount of 1,200 mJ/cm² using a 365 nm LED UV exposure machine under the conditions of 155° C. in a nitrogen atmosphere to produce an optically-anisotropic layer H-1 having a thickness of 1.5 μm.

The optically-anisotropic layer H-1 included one specific region, and a proportion of the specific region in the entire layer was 100% (the entire layer was the specific region and a thickness of the specific region was 1.5 μm).

### Formation of Optically-Anisotropic Layer I-1

The following composition IL-1 was prepared by adding 3 parts by mass of a chiral agent (manufactured by BASF SE, Paliocolor LC756) to the composition HL-1. An addition amount of the chiral agent was adjusted such that a central reflection wavelength of the cholesteric liquid crystal layer obtained using the composition IL-1 was 900 nm.

Composition IL-1

| | | |
|---|---|---|
| Polymerizable liquid crystal compound LC1 | 93.0 | parts by mass |
| Phloroglucinol (manufactured by Tokyo | 7.0 | parts by mass |
| Chemical Industry Co., Ltd.) | | |
| Triphenylphosphine (manufactured by Tokyo | 3.0 | parts by mass |
| Chemical Industry Co., Ltd.) | | |
| Chiral agent (manufactured by BASF SE, | 3.0 | parts by mass |
| Paliocolor LC756) | | |
| UV agent 1 (manufactured by Sigma-Aldrich | 5.0 | parts by mass |
| Co., LLC) | | |
| Polymerization initiator (manufactured by | 4.0 | parts by mass |
| BASF, Omnirad OXE01) | | |
| Leveling agent T-1 | 0.1 | parts by mass |
| Tetrahydrofuran | 213 | parts by mass |
| Dichloromethane | 638 | parts by mass |

The composition IL-1 was applied onto the alignment film of the prepared substrate with an alignment film by spin coating under the conditions of 1,000 rpm and 10 seconds to form a coating film, and the coating film was heated at 90° C. for 1 minute (step 1).

Subsequently, the coating film was cooled to 30° C., and the coating film was irradiated with ultraviolet rays having a wavelength of 365 nm at an irradiation amount of 2 mJ/cm² from the quartz glass substrate side using a 365 nm LED UV exposure machine in a nitrogen atmosphere (step 2).

Subsequently, the coating film irradiated with light was heated at 155° C. for 3 minutes in a nitrogen atmosphere (step 3).

Subsequently, the coating film was irradiated with ultraviolet rays having a wavelength of 365 nm at an irradiation amount of 1,200 mJ/cm² using a 365 nm LED UV exposure machine under the conditions of 155° C. in a nitrogen atmosphere to produce an optically-anisotropic layer I-1 having a thickness of 1.5 μm.

The optically-anisotropic layer I-1 included one specific region, and a proportion of the specific region in the entire layer was 100% (the entire layer was the specific region and a thickness of the specific region was 1.5 μm).

### Example 2

Optically-anisotropic layers H-1A and I-1A were produced in the same manner as in Example 1, except that, in the step 2 of the production of the optically-anisotropic layer H-1 and the step 2 of the production of the optically-anisotropic layer I-1, the coating film was irradiated with ultraviolet rays having a wavelength of 365 nm at an irradiation amount of 2 mJ/cm² from the air interface side, instead of the substrate side.

Subsequently, the compositions HL-1 and IL-1 were applied onto the produced optically-anisotropic layers H-1A and I-1A by spin coating under the conditions of 1,000 rpm and 10 seconds, respectively, to form a coating film, and the coating film was heated at 90° C. for 1 minute.

Subsequently, the coating film was cooled to 30° C., and the coating film was irradiated with ultraviolet rays having a wavelength of 365 nm at an irradiation amount of 100 mJ/cm² from the quartz glass substrate side using a 365 nm LED UV exposure machine in a nitrogen atmosphere.

Subsequently, the coating film irradiated with light was heated at 155° C. for 3 minutes in a nitrogen atmosphere.

Subsequently, the coating film was irradiated with ultraviolet rays having a wavelength of 365 nm at an irradiation amount of 1,200 mJ/cm² using a 365 nm LED UV exposure machine under the conditions of 155° C. in a nitrogen atmosphere to produce each of an optically-anisotropic layer H-2 and an optically-anisotropic layer I-2, having a thickness of 3.0 μm.

As shown in FIG. 3, the optically-anisotropic layers H-2 and I-2 included two specific regions, and a proportion of the two specific regions in the entire layer was 100% (the entire layer was the specific regions, a thickness of each specific region was 1.5 μm, and the total thickness was 3.0 μm).

### Example 3

Optically-anisotropic layers H-3 and I-3 were produced by the same method as in Example 1, except that a polymerizable liquid crystal compound LC2 was used instead of the polymerizable liquid crystal compound LC1.

As shown in FIG. 1, the optically-anisotropic layers H-3 and I-3 included one specific region, and a proportion of the specific region in the entire layer was 20% (a thickness of the specific region was 0.3 μm).

### Polymerizable Liquid Crystal Compound LC2

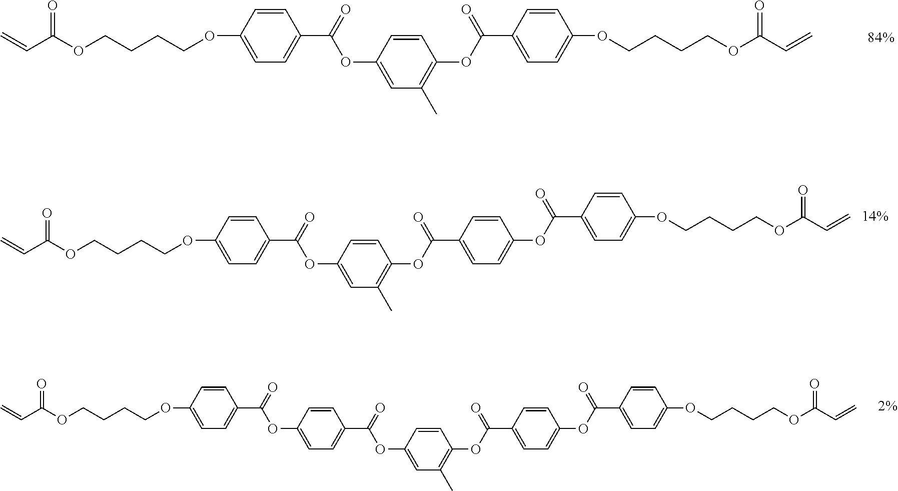

### Comparative Example 1

An optically-anisotropic layer HC-1 was produced according to a method described in Example 1 of JP1999-512849A (JP-H11-512849A), except that a chiral agent was not used. Furthermore, an optically-anisotropic layer IC-1 was produced according to the method described in Example 1 of JP1999-512849A (JP-H11-512849A).

### Comparative Example 2

### Formation of Optically-Anisotropic Layer HC-2

As a composition for forming an optically-anisotropic layer, the following composition HCL-2 was prepared.

Composition HCL-2

| | | |
|---|---|---|
| Polymerizable liquid crystal compound LC1 | 100.0 | parts by mass |
| Polymerization initiator (manufactured by | 3.0 | parts by mass |
| BASF, Omnirad OXE01) | | |
| Leveling agent T-1 | 0.1 | parts by mass |
| Tetrahydrofuran | 213 | parts by mass |
| Dichloromethane | 638 | parts by mass |

The composition HCL-2 was applied onto the alignment film of the prepared substrate with an alignment film by spin coating under the conditions of 1,000 rpm and 10 seconds to form a coating film, and the coating film was heated at 90° C. for 1 minute. Subsequently, the coating film was irradiated with ultraviolet rays having a wavelength of 365 nm at an irradiation amount of 1,200 mJ/cm² using a 365 nm LED UV exposure machine under the conditions of 90° C. in a nitrogen atmosphere to produce an optically-anisotropic layer HC-2 having a thickness of 1.5 μm.

In the optically-anisotropic layer HC-2, a birefringence index Δn did not change in the thickness direction.

### Formation of Optically-Anisotropic Layer IC-2

As a composition for forming an optically-anisotropic layer IC-2, the following composition ICL-2 was prepared.

Composition ICL-2

| | | |
|---|---|---|
| Polymerizable liquid crystal compound LC1 | 100.0 | parts by mass |
| Chiral agent (manufactured by BASF SE, | 3.0 | parts by mass |
| Paliocolor LC756) | | |
| Polymerization initiator (manufactured by | 3.0 | parts by mass |
| BASF, Omnirad OXE01) | | |
| Leveling agent T-1 | 0.1 | parts by mass |
| Tetrahydrofuran | 213 | parts by mass |
| Dichloromethane | 638 | parts by mass |

The composition ICL-2 was applied onto the alignment film of the prepared substrate with an alignment film by spin coating under the conditions of 1,000 rpm and 10 seconds to form a coating film, and the coating film was heated at 90° C. for 1 minute. Subsequently, the coating film was irradiated with ultraviolet rays having a wavelength of 365 nm at an irradiation amount of 1,200 mJ/cm² using a 365 nm LED UV exposure machine under the conditions of 90° C. in a nitrogen atmosphere to produce an optically-anisotropic layer IC-2 having a thickness of 1.5 μm.

In the optically-anisotropic layer IC-2, a birefringence index Δn did not change in the thickness direction.

### Evaluation

### Measurement of Birefringence Index Δn

The optically-anisotropic layer H-1 was etched using a gas cluster ion beam (GCIB), and regions having thicknesses of 0.0 μm, 0.1 μm, 0.2 μm, . . . , and 1.5 μm were produced at intervals of 0.1 μm from an interface between the alignment film and the optically-anisotropic layer, respectively, and the regions were referred to as a region 0, a region 1, a region 2, . . . , and a region 15. For each region, a phase difference at a wavelength of 400 to 800 nm was measured using Axoscan (manufactured by Axometrics, Inc.), and then a phase difference per thickness of 0.1 μm of each region at heights of 0.0 to 0.1 μm, 0.1 to 0.2 μm, . . . , and 1.4 to 1.5 μm from the interface between the alignment film and the optically-anisotropic layer was calculated from the difference between the regions. Furthermore, the birefringence index Δn of each region was calculated from the phase difference of each region. The above-described phase difference and birefringence index Δn are values at a wavelength of 550 nm. In the optically-anisotropic layer H-1, Δn at a height of 0.0 to 0.1 μm was 0.06, Δn at a height of 1.4to 1.5 μm was 0.01, and the ratio thereof was 6 times.

In addition, the characteristics of the wavelength dispersion were specified by the procedure a) to c) described above.

The optically-anisotropic layer H-1 included a region where the phase difference and the birefringence index Δn of each region per thickness of 0.1 μm continuously decreased toward one surface side. In addition, in the region, the wavelength dispersion was constant (that is, Δn450S/Δn550S was within a range of ±5% of Δn450L/Δn550L). Accordingly, as shown in FIG. 1, the optically-anisotropic layer H-1 had one region (specific region) where the birefringence index Δn continuously changed in the thickness direction and the wavelength dispersion was constant in the thickness direction. As shown in FIG. 1, the specific region was disposed along the thickness direction from one surface of the optically-anisotropic layer.

In a case where the above-described measurement was performed using the optically-anisotropic layers H-2 and H-3 and the optically-anisotropic layers I-1 to I-3, instead of the optically-anisotropic layer H-1, the specific region was included in any of the optically-anisotropic layers H-2 and H-3 and the optically-anisotropic layers I-1 to I-3.

Specifically, in the optically-anisotropic layer H-3 and the optically-anisotropic layers I-1 and I-3, similarly to the optically-anisotropic layer H-1, regions (specific regions) where the phase difference and the birefringence index Δn of each region per 0.1 μm thickness continuously decreased toward one surface side and the wavelength dispersion was constant were included. As shown in FIG. 1, the specific region was disposed along the thickness direction from one surface of the optically-anisotropic layer.

In the optically-anisotropic layer H-2 and the optically-anisotropic layer I-2, as shown in FIG. 3, two specific regions were included. That is, one specific region of the two specific regions was located on one surface side of the optically-anisotropic layer, in the one specific region, the birefringence index Δn gradually decreased in the direction from the center position of the film thickness of the optically-anisotropic layer toward the one surface, the other specific region of the two specific regions was located on the other surface side of the two surfaces of the optically-anisotropic layer, and in the other specific region, the birefringence index Δn gradually decreased in the direction from the center position of the film thickness of the optically-anisotropic layer toward the other surface. In any of the specific regions, the wavelength dispersion was constant in the thickness direction. As shown in FIG. 3, the one specific region was disposed along the thickness direction from one surface of the optically-anisotropic layer, and the other specific region was disposed along the thickness direction from the other surface of the optically-anisotropic layer.

On the other hand, the specific region was not included in the optically-anisotropic layers HC-1 and IC-1 and the optically-anisotropic layers HC-2 and IC-2.

### Evaluation of Ratio of Birefringence Indexes Δn

Regarding the optically-anisotropic layers H-1 to H-3 having the specific region, the highest value among the birefringence indexes Δn per region each having a thickness of 0.1 μm included in each specific region, which was calculated in (Measurement of birefringence index Δn) described above, was defined as a birefringence index Δnₘₐₓ, and the lowest value was defined as a birefringence index Δnₘᵢₙ. A ratio of the birefringence index Δnₘₐₓ to the birefringence index Δnₘᵢₙ was calculated and evaluated according to the following standard.
A: the ratio was 2.0 or more.
B: the ratio was less than 2.0.

### (Measurement of Thickness of Specific Region)

Regarding the optically-anisotropic layers H-1 to H-3 having the specific region, the thickness of the specific region was obtained and evaluated according to the following standards.
A: the thickness of the specific region was 0.5 μm or more.
B: the thickness of the specific region was less than 0.5 μm.

### (Evaluation of Interface Antireflection)

Using a spectrophotometer (UV-3100, manufactured by Shimadzu Corporation), transmittances of the optically-anisotropic layers H-1 to H-3 and HC-1 and HC-2 at a wavelength of 550 nm were measured and evaluated according to the following standards. As the value of the transmittance is larger, antireflection property is more excellent.
AA: 90.8% or more
A: 90.5% or more and less than 90.8%
B: 90.3% or more and less than 90.5%
C: less than 90.3%

### (Evaluation of Side Lobe)

Using a spectrophotometer (UV-3100, manufactured by Shimadzu Corporation), transmittances of the optically-anisotropic layers I-1 to I-3 and IC-1 to IC-2 at a wavelength of 450 to 650 nm were measured and evaluated. As the value of the transmittance is larger, side lobe is suppressed.
AA: average transmittance was 90% or more.
A: average transmittance was 89% or more and less than 90%.
B: average transmittance was 88% or more and less than 89%.
C: average transmittance was less than 88%.

In Table 1, in the column of “Liquid crystal compound”, “LC1” indicates that the polymerizable liquid crystal compound LC1 was used; and “LC2” indicates that the polymerizable liquid crystal compound LC2 was used.

In Table 1, in the column of “Specific region”, “1” indicates that the optically-anisotropic layer included one specific region, “2” indicates that the optically-anisotropic layer included two specific regions, and “0” indicated that the optically-anisotropic layer did not include the specific region.

In Table 1, the column of “Δn ratio” indicates the evaluation results of (Evaluation of ratio of birefringence indexes Δn) described above.

In Table 1, the column of “Δnₘₐₓ” indicates the largest value of the birefringence index Δnₘₐₓ in the specific region.

In Table 1, the column of “Δnₘᵢₙ” indicates the smallest value of the birefringence index Δnₘᵢₙ in the specific region.

In Table 1, the column of “Thickness of specific region” indicates the evaluation results of (Measurement of thickness of specific region) described above.

In Table 1, the column of “Film thickness [μm]” indicates the film thickness [μm] of the optically-anisotropic layer.

In Table 1, the column of “Thickness of specific region [μm]” indicates the thickness [μm] of the specific region.

In Table 1, the column of “Specific region ratio” indicates the proportion of the thickness of the specific region to the film thickness of the optically-anisotropic layer.

TABLE 1

| | Liquid | | | | | | Thickness | Film | Thickness | Specific | Evaluation | Evaluation |
|---|---|---|---|---|---|---|---|---|---|---|---|---|
| | crystal | Specific | Δn | | | Δnₘₐₓ/ | of specific | thickness | of specific | region | of interface | of side |
| | compound | region | ratio | Δnₘₐₓ | Δnₘᵢₙ | Δnₘᵢₙ | region | [μm] | region [μm] | ratio | antireflection | lobe |
| Example 1 | LC1 | 1 | A | 0.06 | 0.01 | 6.0 | A | 1.5 | 1.5 | 100% | A | A |
| Example 2 | LC1 | 2 | A | 0.06 | 0.01 | 6.0 | A | 3 | 3 | 100% | AA | AA |
| Example 3 | LC2 | 1 | B | 0.15 | 0.10 | 1.5 | B | 1.5 | 0.3 | 20% | B | B |
| Comparative | — | 0 | — | — | — | — | — | 1.5 | 0 | 0% | C | C |
| Example 1 | | | | | | | | | | | | |
| Comparative | — | 0 | — | — | — | — | — | 1.5 | 0 | 0% | C | C |
| Example 2 | | | | | | | | | | | | |

As shown in Table 1, it was found that the optically-anisotropic layers according to the embodiment of the present invention exhibited a desired effect.

Among these, from the comparison of Examples 1 to 3, it was found that the effect was more excellent in a case where the ratio of the birefringence index Δnₘₐₓ to the birefringence index Δnₘᵢₙ was 2.0 or more and the thickness of the specific region was 0.5 μm or more.

In addition, from the comparison of Examples 1 and 2, it was found that the effect was more excellent in a case where the optically-anisotropic layer had two specific regions.

### Example 4

### Formation of Photo-Alignment Film

A glass substrate was prepared as a support (first support). The following coating liquid for forming a photo-alignment film was applied to the support using a spin coater at 2,500 rpm for 30 seconds. The support on which the coating film of the coating liquid for forming a photo-alignment film was formed was dried using a hot plate at 60° C. for 60 seconds to form a photo-alignment film.

Coating liquid for forming photo-alignment film

| | | |
|---|---|---|
| Material for photo-alignment | 1.00 | part by mass |
| Water | 16.00 | parts by mass |
| Butoxyethanol | 42.00 | parts by mass |
| Propylene glycol monomethyl ether | 42.00 | parts by mass |

### Material For Photo-Alignment (See Structural Formula Below)

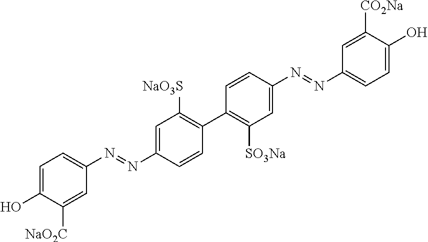

### Exposure of Photo-Alignment Film

In an environment of a temperature of 25° C. and a relative humidity of 10%, the photo-alignment film was exposed using the exposure device shown in FIG. 8 to form a photo-alignment film P-1 having an alignment pattern.

In the exposure device, a laser which emits laser beam having a wavelength (325 nm) was used as the laser. An exposure amount of the interference light was set to 3,000 mJ/cm². An intersecting angle (intersecting angle α) between two laser beams was 9.3°.

The composition IL-1 was applied using the same method as that of Example 2 to produce an optically-anisotropic layer I-4, except that the above-described photo-alignment film P-1 was used instead of the alignment film. By the above-described measuring method, it was also found that the optically-anisotropic layer I-4 had a specific region where the birefringence index Δn continuously changed and the wavelength dispersion was constant. In addition, it was visually confirmed that the optically-anisotropic layer I-4 did not exhibit diffraction in visible light, and the diffraction of visible light due to side lobe was suppressed.

### EXPLANATION OF REFERENCES

10A, 10B, 10C: optically-anisotropic layer
12A, 12B: specific region
14a, 14b, 14c, 14d: divided region
20: alignment substrate
20: support
22: alignment film
24: coating film
26: first region
28: second region
30: liquid crystal compound
30A: optical axis
40: support
42: coating film
60: exposure device
62: laser
64: light source
65: λ/2 plate
68: beam splitter
70A, 70B: mirror
72A, 72B: λ/4 plate

What is claimed is:

1. An optically-anisotropic layer formed of a composition containing a liquid crystal compound,
wherein the optically-anisotropic layer has at least one region where a birefringence index Δn continuously changes in a thickness direction and a wavelength dispersion is constant in the thickness direction.

2. The optically-anisotropic layer according to claim 1,
wherein, in the region, the birefringence index Δn gradually decreases in a direction from one surface of the optically-anisotropic layer toward the other surface of the optically-anisotropic layer.

3. The optically-anisotropic layer according to claim 1,
wherein the optically-anisotropic layer has two regions,
one region of the two regions is located on a surface side of any one of the two surfaces of the optically-anisotropic layer,
in the one region, the birefringence index Δn gradually decreases in a direction from a center position of a film thickness of the optically-anisotropic layer toward the one surface,
the other region of the two regions is located on the other surface side of the two surfaces of the optically-anisotropic layer, and
in the other region, the birefringence index Δn gradually decreases in a direction from the center position of the film thickness of the optically-anisotropic layer toward the other surface.

4. The optically-anisotropic layer according to claim 1,
wherein a thickness of the region is 0.5 μm or more.

5. The optically-anisotropic layer according to claim 1,
wherein, in the region, a ratio of a highest birefringence index Δnₘₐₓ to a lowest birefringence index Δnₘᵢₙ is 2.0 or more.

6. The optically-anisotropic layer according to claim 1,
wherein the optically-anisotropic layer is a layer formed by immobilizing the liquid crystal compound which is cholesterically aligned.

7. The optically-anisotropic layer according to claim 1,
wherein the liquid crystal compound has a cationically polymerizable group.

8. The optically-anisotropic layer according to claim 1,
wherein the composition contains a phenolic compound.

9. The optically-anisotropic layer according to claim 1,
wherein the composition contains an ultraviolet absorber.

10. The optically-anisotropic layer according to claim 1,
wherein the optically-anisotropic layer has a liquid crystal alignment pattern in which an orientation of an optical axis derived from the liquid crystal compound changes while continuously rotating in at least one in-plane direction.

11. A manufacturing method of the optically-anisotropic layer according to claim 1, the manufacturing method comprising:
a step 1 of forming a coating film using a composition which contains a liquid crystal compound having a polymerizable group, and aligning the liquid crystal compound in the formed coating film;
a step 2 of polymerizing the liquid crystal compound such that a region where a polymerization rate of the liquid crystal compound continuously changes is formed in a thickness direction of the coating film; and
a step 3 of subjecting the coating film obtained in the step 2 to a heating treatment to form a region where a birefringence index Δn continuously changes in the thickness direction and a wavelength dispersion is constant.

12. The optically-anisotropic layer according to claim 2,
wherein the optically-anisotropic layer has two regions,
one region of the two regions is located on a surface side of any one of the two surfaces of the optically-anisotropic layer,
in the one region, the birefringence index Δn gradually decreases in a direction from a center position of a film thickness of the optically-anisotropic layer toward the one surface,
the other region of the two regions is located on the other surface side of the two surfaces of the optically-anisotropic layer, and
in the other region, the birefringence index Δn gradually decreases in a direction from the center position of the film thickness of the optically-anisotropic layer toward the other surface.

13. The optically-anisotropic layer according to claim 2,
wherein a thickness of the region is 0.5 μm or more.

14. The optically-anisotropic layer according to claim 2,
wherein, in the region, a ratio of a highest birefringence index Δnₘₐₓ to a lowest birefringence index Δnₘᵢₙ is 2.0 or more.

15. The optically-anisotropic layer according to claim 2,
wherein the optically-anisotropic layer is a layer formed by immobilizing the liquid crystal compound which is cholesterically aligned.

16. The optically-anisotropic layer according to claim 2,
wherein the liquid crystal compound has a cationically polymerizable group.

17. The optically-anisotropic layer according to claim 2,
wherein the composition contains a phenolic compound.

18. The optically-anisotropic layer according to claim 2,
wherein the composition contains an ultraviolet absorber.

19. The optically-anisotropic layer according to claim 2,
wherein the optically-anisotropic layer has a liquid crystal alignment pattern in which an orientation of an optical axis derived from the liquid crystal compound changes while continuously rotating in at least one in-plane direction.

20. A manufacturing method of the optically-anisotropic layer according to claim 2, the manufacturing method comprising:
a step 1 of forming a coating film using a composition which contains a liquid crystal compound having a polymerizable group, and aligning the liquid crystal compound in the formed coating film;
a step 2 of polymerizing the liquid crystal compound such that a region where a polymerization rate of the liquid crystal compound continuously changes is formed in a thickness direction of the coating film; and
a step 3 of subjecting the coating film obtained in the step 2 to a heating treatment to form a region where a birefringence index Δn continuously changes in the thickness direction and a wavelength dispersion is constant.
